(19) United States
(12) Patent Application Publication
(10) Pub. No.: US 2025/0348671 A1
(43) Pub. Date: Nov. 13, 2025

(54) METHODS AND SYSTEMS FOR GENERATING TEXTUAL OUTPUTS FROM IMAGES

(71) Applicant: MAERSK A/S, Copenhagen K (DK)

(72) Inventors: Sachin Dadasaheb CHAUDHARI, Bangalore (IN); Sunil Kumar CHINNAMGARI, Bangalore (IN); Vamshidhar GULLAPALLI, Bangalore (IN); Prasad SETTYPALLE, Bangalore (IN)

(21) Appl. No.: 18/871,443

(22) PCT Filed: Jun. 12, 2023
(86) PCT No.: PCT/EP2023/065658

§ 371 Date: Dec. 3, 2024

(30) Foreign Application Priority Data
Jun. 14, 2022 (DK) PA202270319

(51) Int. Cl. G06F 40/279; G06V 30/10

(52) U.S. Cl. CPC G06F 40/279; G06V 30/10

(57) ABSTRACT

Embodiments of the present disclosure provide systems and methods for performing text extraction from an image including textual data. The method performed by a processor includes extracting machine-readable textual data from the image. The machine-readable textual data includes one or more words. The method includes comparing each of the one or more words with a dataset including a domain lexicon database and a language dictionary database to determine a first set of words and a second set of words. The first set of words is words successfully matching with words available in the dataset, and the second set of words is words with no successful match with words available in the dataset. Further, the method includes splitting at least one word of the second set of words into two or more words to determine a third set of words and generating a textual output associated with the image.

### TECHNICAL FIELD

The present disclosure relates to electronic image processing and textual content recognition thereof and, more particularly relates, to systems and methods for generating textual output from electronic images with improved accuracy.

### BACKGROUND

Digitization of paper documents is a need for many users either in personal space or business environment, where users digitize paper documents such as financial statements, government documents, legal papers, medical records, logistic invoices, shipping documents, tax forms, and the like. Oftentimes, users need to convert the text of these documents into machine-readable data for record-keeping purposes and to make the data searchable. Optical character recognition (OCR) is a well-known technique used for the electronic or mechanical conversion of paper documents (containing printed and/or hand-written text) into digitized form (e.g., machine-encoded text). Generally, a commercially available scanner is used to scan a given paper document to produce a raster image. In general, the raster image is compiled using a rectangular matrix or grid of square pixels. The raster image is further passed through commercially available software, for example, an OCR engine. The OCR engine processes the raster image to recognize elements (e.g., characters, words, numerical digits, special characters, etc.) to generate textual data as an output.

It is observed that the OCR engine generally has some limitations, for example, the OCR engine may make errors during text extraction for a few words even on clean and high-quality electronic images of the documents. Many electronic images of the documents in day-today operations may not be clean or of good quality, may be distorted during scanning, and/or degraded during post-scanning binarization. In such documents, some of the labels required for the extraction of textual information are not identifiable; therefore, the textual information may not be correctly extracted. Although increasing the quality of the image may lead to better text extraction as compared to the raw image, the OCR technology may still fail to provide significant improvement in text extraction, and the extracted text may have errors.

### SUMMARY

There exists a need for techniques to overcome one or more limitations stated above such as inaccurate extraction of textual information from even relatively low-quality images and correction of extracted textual information in addition to providing other technical advantages. Various embodiments of the present disclosure provide systems and methods for generating textual outputs from images with increased accuracy. Various embodiments of the present disclosure describe a computing device or a tool that enables text processing over texts extracted from images and reduces time in handling erroneous texts while improving the accuracy of text extraction. The disclosed technique enables an automated text correction with help of domain and language-specific knowledge databases.

To achieve the above and other objectives of the present disclosure, in one aspect, a computer-implemented method is disclosed. The computer-implemented method, performed by a processor, includes receiving an image including textual data. The method further includes extracting machine-readable textual data from the image. The machine-readable textual data includes one or more words. Furthermore, the method includes comparing each of the one or more words with a dataset including at least one of a domain lexicon database and a language dictionary database to determine a first set of words and a second set of words. The first set of words is words successfully matching with words available in the dataset, and the second set of words is words with no successful matches with the words available in the dataset. Moreover, the method includes splitting at least one word of the second set of words into two or more words to determine a third set of words that matches with the words available in the dataset. The method also includes generating a textual output associated with the image based at least on the first set of words and the third set of words.

An advantage of some embodiments is that the image can be received from various sources, including, for example, a commercially available scanner, a commercially available camera, a memory, or the internet via a network connection. Further, the machine-readable textual data is extracted from the image based on any character recognition engine. Furthermore, an advantage of some embodiments is that the one or more words included in the machine-readable textual data are compared with the entire dataset including both the domain lexicon database (e.g., specific words related to a particular industry domain) and the language dictionary database. Such comparison ensures that even those words that are not present in the language dictionary database but in the domain lexicon database, are also compared and successfully matched. Another advantage of some embodiments is to correct those words which may have been concatenated by mistake by splitting the second set of words and matching the split words in the dataset. For example, performing the split step for some second set of words (e.g., concatenated words) ensures that these words are corrected by the processor before generating the textual output (i.e., the final output).

In an aspect, the step of comparing each of the one or more words includes calculating a highest similarity score for each of the second set of words with the words available in the dataset. Upon determining that the highest similarity score is at least equal to a threshold similarity score, the method includes detecting a word from the dataset corresponding to the highest similarity score as a corrected word for the respective word of the second set of words. In addition, the method includes categorizing the corrected word as the first set of words.

An advantage of some embodiments is that the second set of words that are not matched with the dataset undergo additional processing steps so that such words can be corrected. The highest domain similarity score is calculated for each word of the second set of words and if the highest domain similarity score is greater than a threshold similarity score, the corresponding second set of words is corrected or replaced with the correct word from the dataset. After correction, all the corrected words are again categorized as the first set of words. Calculation of the highest similarity score ensures correction of the second set of words with increased accuracy.

In an aspect, the method includes splitting the at least one word of the second set of words into two or more words based, at least in part, on a predefined text parsing rule. Furthermore, the method includes comparing the two or more words with the dataset to determine successful matches for the two or more words in the dataset. The method also includes categorizing the two or more words into the third set of words in response to determining that the two or more words have successful matches in the dataset.

An advantage of some embodiments is that even those second set of words that are not corrected after the calculation of the highest similarity score (i.e., concatenated words), can be corrected via additional processing. Based on the teachings of at least some embodiments of the present disclosure, these words are also corrected by performing the splitting step based on the predefined text parsing rule. Each concatenated word is split into two or more words, and if the two or more words are meaningful words that have matches in the dataset, the two or more words are categorized as the third set of words.

In an aspect, the textual output is generated based on the first set of words, the second set of words that remain unmatched, and the third set of words. An advantage of such embodiments is that the textual output is comprehensive and covers all the words of the input image after correction procedures.

In an aspect, the language dictionary database is configured to store words in accordance with syntactic rules and semantic rules of at least one language, and the domain lexicon database is configured to store keywords corresponding to at least one domain. An advantage of some embodiments is that language database includes a collection of words of at least one language and the domain lexicon database also includes a collection of words of at least one domain, and these collections are used for the comparison purposes ensuring the correction of words present in the machine-readable textual data with increased accuracy.

In an aspect, the image is processed based on at least one image pre-processing operation to enhance the quality of the image, prior to extracting the machine-readable textual data from the image. At least one image pre-processing operation includes at least one of: (a) adaptive thresholding method, (b) image enhancement method, and (c) de-skewing method. An advantage of some embodiments is that even if the image is of low quality, the image has to undergo various image pre-processing operations to enhance its quality. In an example, the adaptive thresholding method includes eliminating grey areas from the image. The image enhancement method includes updating one or more image parameters of the image. The one or more image parameters include at least one of: (a) brightness, (b) contrast, (c) sharpness, and (d) aspect ratio. In yet another aspect, the de-skewing method includes altering a skew angle of the image.

An advantage of some embodiments is that to improve the quality of the image, the image is subjected to various pre-processing operations before performing the text extraction. The various pre-processing operations may be related to the orientation of the image, brightness or contrast of the image, sharpness or aspect ratio of the image, skew angle of the image, and so on.

In another aspect, a computing device is disclosed. The computing device includes a memory including executable instructions and a processor. The processor is communicably coupled to the memory. The processor is configured to execute the instructions to cause the computing device, at least in part, to receive an image including textual data. The computing device is further caused to extract machine-readable textual data from the image. The machine-readable textual data includes one or more words. Furthermore, the computing device is caused to compare each of the one or more words with a dataset including at least one of a domain lexicon database and a language dictionary database to determine a first set of words and a second set of words. The first set of words is words successfully matching with words available in the dataset, and the second set of words is words with no successful matches with the words available in the dataset. Moreover, the computing device is caused to split at least one of the second set of words into two or more words to determine a third set of words that matches with the words available in the dataset. The computing device is also caused to generate a textual output associated with the image based at least on the first set of words and the third set of words.

In yet another aspect, a non-transitory computer-readable storage medium is disclosed. The non-transitory computer-readable storage medium includes computer-executable instructions. The computer-executable instructions, when executed by at least a processor of a computing device, cause the computing device to perform a method. The method includes receiving an image including textual data. The method further includes extracting machine-readable textual data from the image. The machine-readable textual data includes one or more words. Furthermore, the method includes comparing each of the one or more words with a dataset including at least one of a domain lexicon database and a language dictionary database to determine a first set of words and a second set of words. The first set of words is words successfully matching with words available in the dataset, and the second set of words is words with no successful matches with the words available in the dataset. Moreover, the method includes splitting at least one word of the second set of words into two or more words to determine a third set of words that matches with the words available in the dataset. The method also includes generating a textual output associated with the image based at least on the first set of words and the third set of words.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1A is an illustration of an environment related to at least some embodiments of the present disclosure;

FIG. 1B is an illustration of another environment related to at least some embodiments of the present disclosure;

FIG. 2 is a simplified block diagram of a computing device, in accordance with an embodiment of the present disclosure;

FIG. 3 is a schematic representation of a process flow for performing intelligent textual output generation, in accordance with an embodiment of the present disclosure;

FIGS. 4A-4G, collectively, represent example representations for performing image pre-processing, character recognition, and text processing on the image, in accordance with an embodiment of the present disclosure;

FIG. 5 is a process flow chart of a computer-implemented method for accurately generating textual outputs from images, in accordance with an embodiment of the present disclosure;

FIG. 6 represents a data flow diagram representation for extracting words from an image and determining a first set of words and a second set of words from the extracted words, in accordance with an embodiment of the present disclosure;

FIG. 7A is a simplified data flow diagram representation for performing additional text processing for the second set of words, in accordance with an embodiment of the present disclosure;

FIG. 7B is a simplified data flow diagram representation for splitting a group of the second set of words (i.e., residual words) to determine corrected words and generating the textual output of the image, in accordance with an embodiment of the present disclosure;

FIG. 8 represents a simplified data flow diagram representation for accurately generating textual outputs from images, in accordance with another embodiment of the present disclosure; and

FIG. 9 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “image”, used throughout the description, refers to an image containing some textual data or information, and it can take the form of a scanned document or captured image of a paper or a scene containing textual information. The image also includes a video frame containing some caption text or screen text.

The term “textual data”, used throughout the description, refers to actual or exact text that is present in the image, and the “textual data” can include text, characters, numbers, alphanumerical characters, or symbols. The term “machine-readable textual data”, used throughout the description, refers to the text that has been extracted from the image based upon execution of a character recognition engine. Some examples of the character recognition engine include an optical character recognition (OCR) engine, an intelligent character recognition (ICR) engine, and the like.

Various embodiments of the present disclosure offer multiple advantages and technical effects. For instance, the present disclosure enables text extraction from low-quality images (for example, images of scanned documents) with improved accuracy. The present disclosure also performs corrections for extracted texts with variations (e.g., typographies, errors, misspelled, truncated, and/or concatenated texts, etc.) by comparing extracted words with words available in one or more domain lexicon databases and/or language dictionary databases. Consequently, using disclosed methods, a faster text extraction for images with increased accuracy may be achieved. Further, the present disclosure provides techniques in which extracted texts can be stored, retrieved, and processed, that improve storage space requirement, the accuracy of text extraction, and the speed of text processing for misspelled words. For example, according to an embodiment, where the input images contain text specific to a particular technical or business domain, during text processing, the disclosed method may first compare an extracted word with words available in the domain lexicon database and then, with words available in the language dictionary database in case the extracted word is not present in the domain lexicon database. Since the domain-lexicon database has a smaller number of words in comparison to the language dictionary database, therefore, such embodiments may reduce the number of search queries in a significant manner, thereby optimizing computer processing requirements.

According to the present disclosure, a computing device is disclosed for performing text extraction from images with increased accuracy. In some embodiments, the computing device may act as a user device or an electronic device. In some embodiments, the computing device may act as a server system.

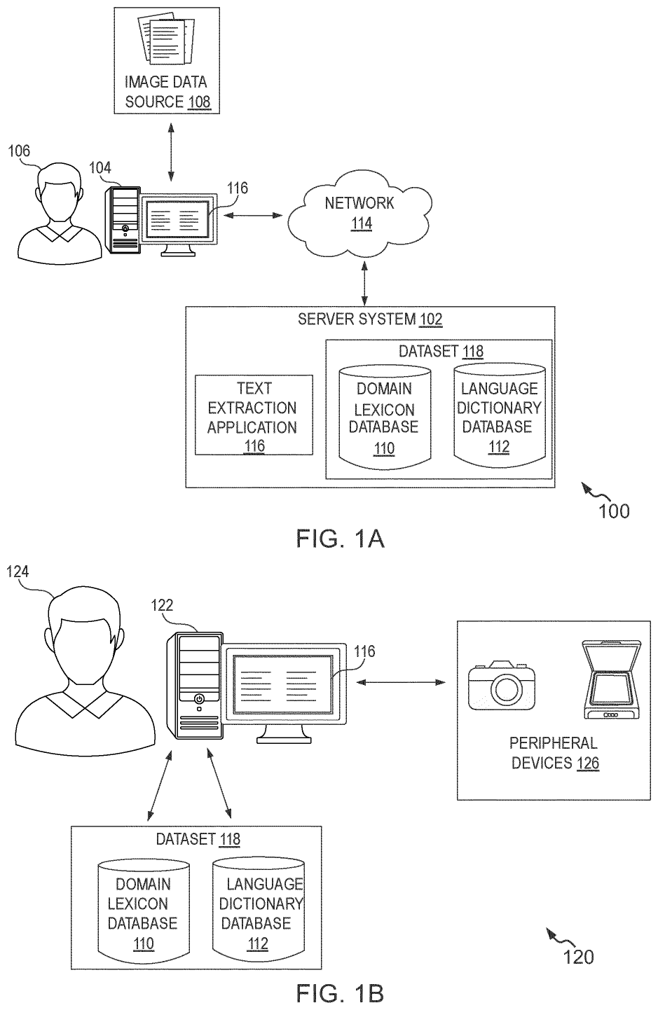

Various example embodiments of the present disclosure are described hereinafter with reference to FIGS. 1A-1B to 9.

FIG. 1A illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, performing text extraction from a low-quality image. The environment 100 generally includes a server system 102, a computing device 104 associated with a user 106, an image data source 108, and a dataset 118 including a domain lexicon database 110 and a language dictionary database 112, each coupled to, and in communication with (and/or with access to) a network 114. The network 114 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1A, or any combination thereof.

Various entities in the environment 100 may connect to the network 114 in accordance with various wired and wireless communication protocols, such as, Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, any future communication protocols, or any combination thereof. In some instances, the network 114 may include a secure protocol (e.g., Hypertext Transfer Protocol (HTTP)), and/or any other protocol, or set of protocols. In an example, the network 114 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1A, or any combination thereof.

The user 106 (e.g., an employee of a company ‘A’) may use the computing device 104 for capturing the image via a camera module of the computing device 104. In one example, the user 106 may scan a document using the computing device 104. The image associated with the scanned document may include at least some portions containing textual data. The textual data can be standard text (e.g., typed characters) or hand-written text. In some scenarios, it may be possible that the image has a low quality that needs to undergo image pre-processing operations, prior to the text extraction. In another example, the image may have been captured, for example, using conventional digital cameras or video recording devices.

Examples of the computing device 104 may include, without limitation, smartphones, tablet computers, scanners, other handheld computers, wearable devices, laptop computers, desktop computers, servers, portable media players, gaming devices, personal digital assistants (PDAs), and so forth.

In one example, the user 106 may access a textual output generation application (also referred to as ‘text extraction application’) 116 via the computing device 104, over the network 114. The text extraction application 116 may be hosted at a remote server such as the server system 102. A local version of the text extraction application 116 at the user's computing device and data associated with the text extraction application 116 may be retrieved over the network 114. In an example, the text extraction application 116 may be or include a web browser which the user 106 may launch to navigate to a website used to perform the intelligent text extraction. In another example, the text extraction application 116 may be a desktop application or a mobile application. In yet another example, the text extraction application 116 may include background processes that perform various operations without direct interaction from the user 106. The text extraction application 116 may include a “plug-in” or “extension” to another application, such as a web browser plug-in or extension. The text extraction application 116 may enable the detection of text in an image document. Upon receiving the image, the text extraction application 116 is configured to apply image processing and text processing methods to obtain textual data associated with the image. In one embodiment, the image pre-processing operations are applied to enhance the quality of a low-quality image, prior to text detection. The text extraction application 116 may analyze the image to determine whether pre-processing of the image is required or not. Alternatively, each image is automatically pre-processed by the text extraction application 116.

In one form, the text extraction application 116 detects one or more candidate regions of an image that contain the text or are likely to contain text. The text in the candidate regions is then identified by a character recognition method. In other words, the text extraction application 116 extracts machine-readable textual data from the image.

It is to be noted that the accuracy of the character recognition method may not be 100%, and therefore, the text extracted from the image may differ from the actual text present in the image. The extraction may be performed based, at least in part, on a character recognition engine. The character recognition engine includes, but is not limited to, an optical character recognition (OCR) engine or an intelligent character recognition (ICR) engine. In one example, the text extraction application 116 may utilize commercially available character recognition engines such as Pytesseract, OpenOCR, and the like, to extract the machine-readable textual data from the image.

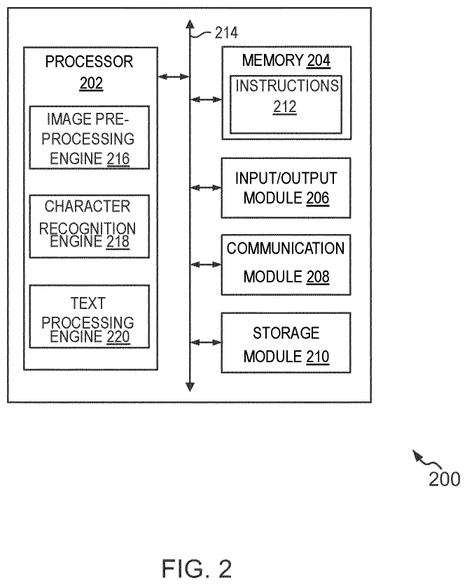

Furthermore, the text extraction application 116 applies text processing operations over the extracted machine-readable textual data to increase the accuracy or readability of the machine-readable textual data. Moreover, the text extraction application 116 generates a textual output associated with the image based on the application of the text processing operations over the extracted machine-readable textual data. A detailed explanation of the application of the text processing operations over the extracted machine-readable textual data is explained hereinafter in detail with reference to FIG. 2.

In one embodiment, the server system 102 is a computing server configured to execute processes further described herein. The server system 102 is a backend server for the text extraction application 116. The server system 102 facilitates text extraction with greater accuracy from low-quality images by utilizing the domain lexicon database 110 and the language dictionary database 112. In particular, the server system 102 is configured to receive an image that may contain blurred or obscured textual data from the computing device 104 associated with the user 106 or the image data source 108. For the images having low quality, the quality of such images is initially enhanced. In an embodiment, the server system 102 is configured to apply an adaptive thresholding method to eliminate grey regions from the image. Additionally, or alternatively, the server system 102 is configured to enhance one or more image parameters including, for example, brightness, contrast, sharpness, aspect ratio, and the like. The server system 102, is also, additionally or alternatively, configured to alter the skew angle (for example, horizontal angle or vertical angle) of the image.

Once the image quality is improved, the server system 102 is configured to perform text extraction to extract the machine-readable textual data from the image. The server system 102 is further configured to tokenize the machine-readable textual data (i.e., the text extracted after performing character recognition) and the one or more words are identified as respective entities such as nouns, organization, places, and the like. Additionally, a dataset 118 of words including a standard language dictionary (i.e., a stock of standard words of a given language stored in the language dictionary database 112) and a domain lexicon (e.g., stock of words containing industry-specific words stored in a domain lexicon database 110) is searched to identify whether each of the one or more words present in the extracted text (i.e., the machine-readable textual data) is available in the dataset 118. The dataset 118 includes words available in the domain lexicon database 110 and the language dictionary database 112.

The words that are matched with the dataset 118 are preserved and considered correct words (the first set of words) and the remaining words (i.e., words that are not found in the dataset 118) are considered misspelled words (the second set of words). The server system 102 is further configured to compare each of the second set of words (i.e., misspelled words) with words available in the domain lexicon database 110. If the highest domain similarity score associated with an individual misspelled word is not greater than a first threshold similarity score, then the individual misspelled word is compared with words available in the language dictionary database 112, and the highest language similarity score for the individual misspelled word is calculated. If the highest language similarity score is not greater than a second threshold similarity score, the individual misspelled word is tagged as a residual word, otherwise, the individual misspelled word is updated based, at least in part, on the associated highest domain similarity score and/or the highest language similarity score. In this manner, the server system 102 is configured to determine the corrected words for some of the misspelled words, and these corrected words are included in the first set of words. It should be noted that now the second set of words only includes the residual words for which corrected words are not available based on a comparison of similarity scores.

Further, the server system 102 is configured to split the second set of words (i.e., residual words) into two or more words as per certain text parsing rules explained later in the present description. If the two or more words are meaningful dictionary words, then the split is considered, otherwise, the residual words are not changed at all.

In one embodiment, the server system 102 may access one or more databases, such as the domain lexicon database 110 and the language dictionary database 112. The domain lexicon database 110 and the language dictionary database 112 may be embodied within the server system 102 or may be separate components. The domain lexicon database 110 is configured to store words corresponding to a particular domain. For example, the particular domain may be related to logistics and shipping, finance, education, medical, advertisement technology, and the like. The language dictionary database 112 is configured to store words in accordance with syntactic rules and semantic rules of at least one language.

In one embodiment, the domain lexicon database 110 is configured to store keywords. In addition, the keywords include words specific to a particular domain or industry. For example, in one implementation, if the domain lexicon database 110 is configured to store keywords related to the medical domain, then the domain lexicon database 110 may include keywords such as health, medical care, daycare, treatment, nursing, Outpatient Department (OPD), Intensive Care Unit (ICU), and the like. In another example, in another implementation, if the domain lexicon database 110 is configured to store keywords related to the finance domain, then the domain lexicon database 110 may include keywords such as investment, loan, insurance, mortgage, mutual fund (MF), systematic investment plan (SIP), Equity-Linked Savings Scheme (ELSS), wealth management, and the like.

The number and arrangement of systems, devices, and/or networks shown in FIG. 1A are provided as an example. There may be additional systems, devices, and/or networks; fewer systems, devices, and/or networks; different systems, devices, and/or networks, and/or differently arranged systems, devices, and/or networks than those shown in FIG. 1A. Furthermore, two or more systems or devices shown in FIG. 1A may be implemented within a single system or device, or a single system or device shown in FIG. 1A may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

It should be noted that the functionalities of the server system can also be implemented in a cloud architecture, a standalone computing device, partially or in its entirety. In such implementations, the text extraction and correction from an image can be performed by a computing device that may not be necessarily connected to an external server, as shown in FIG. 1B.

FIG. 1B illustrates an exemplary representation of another environment 120 related to at least some embodiments of the present disclosure. Although the environment 120 is presented in one arrangement, other embodiments may include the parts of the environment 120 (or other parts) arranged otherwise depending on, for example, performing text extraction from low-quality images. The environment 120 generally includes a computing device 122 associated with a user 124, peripheral devices 126, the domain lexicon database 110, and the language dictionary database 112.

The user 124 is authorized to access the computing device 122 to launch the text extraction application 116. The text extraction application 116 is installed inside the computing device 122. In one example, the computing device 122 is a desktop computer situated inside a facility. Examples of the facility may include warehouses, institutions, organizations, buildings, and the like. The user 124 is further present inside the facility to operate the computing device 122 to access the text extraction application 116. In an example, the text extraction application 116 is pre-installed in the computing device 122. In another example, the text extraction application 116 is installed in the computing device 122 via storage medium (for example, hard disk drive (HDD), solid-state drive (SSD), flash drive, pen drive, compact disc (CD), Blu-ray disc, and the like).

The peripheral devices 126 are connected with the computing device 122. Examples of the peripheral devices 126 include but may not be limited to a camera and a scanner. In an embodiment, the user 124 may utilize the peripheral devices 126 (for example, camera) to initially capture the image, and then the image is uploaded to the text extraction application 116 in an offline manner (i.e., without the use of the Internet). In another embodiment, the user 124 may utilize the peripheral devices 126 (for example, scanner) to initially scan the image, and then the scanned image is accessed via the text extraction application 116 in an offline manner (i.e., without the use of the Internet).

The domain lexicon database 110 and the language dictionary database 112 are connected with or stored electronically inside the computing device 122. The text extraction application 116 may access the domain lexicon database 110 and the language dictionary database 112 in an offline manner (i.e., without the use of the Internet).

The user 124 may access the text extraction application 116, offline without the use of the Internet. The text extraction application 116 may be downloaded in the computing device 122 from a remote server, for example, the server system 102 of FIG. 1A. The computing device 122 can connect to the network 114 of FIG. 1A to download the text extraction application 116 at any point in time. In an example, the text extraction application 116 may be or include a web browser which the user 124 may launch to navigate to a website used to perform the intelligent text extraction. In another example, the text extraction application 116 may be a desktop application or a mobile application. In yet another example, the text extraction application 116 may include background processes that perform various operations without direct interaction from the user 124. The text extraction application 116 may include a “plug-in” or “extension” to another application, such as a web browser plug-in or extension.

The text extraction application 116 may enable the detection of text in the image document. Upon receiving the image, the text extraction application 116 is configured to apply image processing and text processing methods to obtain textual data associated with the image. In one embodiment, the image pre-processing operations are applied to enhance the quality of a low-quality image, prior to text detection. The text extraction application 116 may analyze the image to determine whether pre-processing operations are required or not. Alternatively, each image is automatically pre-processed by the text extraction application 116.

The text extraction application 116 further applies text processing operations over the extracted machine-readable textual data to increase the accuracy or readability of the machine-readable textual data. Moreover, the text extraction application 116 generates a textual output associated with the image based on the application of the text processing operations over the extracted machine-readable textual data. A detailed explanation of the application of the text processing operations over the extracted machine-readable textual data is explained hereinafter in detail with reference to FIG. 2, and therefore, it is not reiterated for the sake of brevity.

In one embodiment, the computing device 122 is a computer system configured to execute processes further described herein. The computing device 122 facilitates text extraction with greater accuracy from low-quality images by utilizing the domain lexicon database 110 and the language dictionary database 112. In particular, the computing device 122 is configured to receive the image containing blurred or obscured textual data with the facilitation of the peripheral devices 126. Then, the computing device 122 is configured to apply image pre-processing operations over the image to enhance the quality of the image. The computing device 122 is further configured to extract the machine-readable textual data from the image based on character recognition techniques (for example, OCR, ICR, and the like). Furthermore, the computing device 122 is configured to apply text processing operations over the machine-readable textual data to generate the textual output associated with the image.

The number and arrangement of systems, devices, and/or networks shown in FIG. 1B are provided as an example. There may be additional systems, devices, and/or networks; fewer systems, devices, and/or networks; different systems, devices, and/or networks, and/or differently arranged systems, devices, and/or networks than those shown in FIG. 1B. Furthermore, two or more systems or devices shown in FIG. 1B may be implemented within a single system or device, or a single system or device shown in FIG. 1B may be implemented as multiple, distributed systems or devices. Additionally, or alternatively, a set of systems (e.g., one or more systems) or a set of devices (e.g., one or more devices) of the environment 120 may perform one or more functions described as being performed by another set of systems or another set of devices of the environment 120.

FIG. 2 is a simplified block diagram of a computing device 200, in accordance with an embodiment of the present disclosure. Examples of the computing device 200 can be the server system 102 or the computing device 122. In some embodiments, the computing device 200 may be embodied as a device in cloud-based and/or SaaS-based (software as a service) architecture.

The computing device 200 includes at least one processor 202 for executing instructions, a memory 204, an input/output module 206, a communication module 208, and a storage module 210 that communicate with each other via a centralized circuit system 214.

The processor 202 includes suitable logic, circuitry, and/or interfaces to execute operations for performing intelligent text extraction from the image including textual data. Examples of the processor 202 include, but are not limited to, an application-specific integrated circuit (ASIC) processor, a reduced instruction set computing (RISC) processor, a graphical processing unit (GPU), a complex instruction set computing (CISC) processor, a field-programmable gate array (FPGA), and the like. The processor 202 includes an image pre-processing engine 216, a character recognition engine 218, and a text processing engine 220. It should be noted that the components, described herein, can be configured in a variety of ways, including electronic circuitries, digital arithmetic and logic blocks, and memory systems in combination with software, firmware, and embedded technologies.

The memory 204 includes suitable logic, circuitry, and/or interfaces to store a set of computer-readable instructions 212 for performing operations. The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash memory, RAM (random access memory), etc.), magnetic storage devices (such as hard disk drives, floppy disks, magnetic tapes, etc.), optical magnetic storage devices (e.g., magneto-optical disks), CD-ROM (compact disc read-only memory), CD-R (compact disc recordable), CD-R/W (compact disc rewritable), DVD (Digital Versatile Disc) and BD (BLU-RAY® Disc).

In at least some embodiments, the memory 204 stores the instructions 212 which may be used by engines of the processor 202 such as the image pre-processing engine 216, the character recognition engine 218, and the text processing engine 220.

As explained above, the memory 204 also stores code/instructions, which are used by the communication module 208. In at least some embodiments, the communication module 208 may use the instructions 212 stored in the memory 204 to receive the image including the textual data from one or more data sources (for example, the image data source 108). The image may include printed text or hand-written text.

It is to be noted that the computing device 200 as illustrated and hereinafter described is merely illustrative of an apparatus that could benefit from embodiments of the present disclosure and, therefore, should not be taken to limit the scope of the present disclosure. It is to be noted that the computing device 200 may include fewer or more components than those depicted in FIG. 2. It should be noted that the components, described herein, can be configured in a variety of ways, including electronic circuitries, digital arithmetic and logic blocks, and memory systems in combination with software, firmware, and embedded technologies.

The image pre-processing engine 216 includes suitable logic and/or interfaces for performing at least one image pre-processing operation over the image. In some embodiments, the textual data may include printed text or hand-written text. The image may include some partially obscured (e.g., unclear or blurred) text. The image pre-processing engine 216 receives the image from the image data source 108. The image data source 108 includes at least one of a local data directory, a third-party external data directory, or an input source. The input source may further include a camera, a printer, a scanner, and the like.

In an example, the user 106 may scan a document (e.g., a paper document) with a commercially available scanner and further upload the image of the document in the text extraction application 116. In another example, the user 106 may upload the image including textual data in the text extraction application 116 from the local directory of a computing device (e.g., the computing device 104) in which the text extraction application 116 is installed. In yet another example, the user 106 may upload the image including textual data in the text extraction application 116 from a third-party external directory connected to the text extraction application via a network (e.g., the network 114).

The image pre-processing engine 216 is configured to perform at least one image pre-processing operation over the image to enhance the quality of the image, prior to extracting the machine-readable textual data from the image. The image pre-processing operation is performed to generate a digitally manipulated version of the image with enhanced quality. In one non-limiting example, pre-processing is performed on the image, when the image includes regions of low contrast. For example, an image document may include shadowed textual portions, reducing the contrast between the textual portions and surrounding features in the image. Additionally, in another implementation, preprocessing is performed to correct image quality problems, for example, the inclusion of compression artifacts.

In some embodiments, the image pre-processing operation includes at least one of: (a) adaptive thresholding method, (b) image enhancement method, and (c) de-skewing method.

The image pre-processing engine 216 is configured to apply the adaptive thresholding method to eliminate grey areas from the image. Generally, the “adaptive thresholding” method is used to separate desirable foreground image objects from the background based on the difference in pixel intensities of each region. More specifically, a threshold value is calculated for each pixel in the image. If the pixel value is below the threshold value, the value is set to the background value, otherwise, the value is set to the foreground value. In one embodiment, the image pre-processing engine 216 is configured to apply the adaptive thresholding method to increase the brightness or white regions in the image. For example, the adaptive thresholding method segments the image into a plurality of windows. The adaptive thresholding method further iterates a window over each of the plurality of windows to calculate an average value to determine a threshold value. Furthermore, the adaptive thresholding method fixes the brightness of the image based on the threshold value. For example, the adaptive thresholding method brightens up those windows of the plurality of windows that are darker than the other windows of the plurality of windows. In this manner, the adaptive thresholding method eliminates the grey areas from the image by brightening up the image and making the characters in the image sharper.

Moreover, the image pre-processing engine 216 is configured to apply the image enhancement method to update one or more image parameters of the image. The one or more image parameters include at least one of: (a) brightness, (b) contrast, (c) sharpness, and (d) aspect ratio. In one embodiment, the image pre-processing engine 216 is configured to apply the image enhancement method to enhance the quality of the image by updating or altering the one or more image parameters including, for example, the brightness of the image, contrast of the image, sharpness of the image, aspect ratio of the image, and the like.

In general, brightness refers to the overall lightness or darkness of the image. In some embodiments, the image pre-processing engine 216 is configured to increase or decrease the brightness of the image based on the quality of the image. In simpler terms, contrast can be defined as the difference between the maximum and minimum pixel intensity in the image. In some embodiments, the image pre-processing engine 216 is configured to increase or decrease the contrast of the image based on the quality of the image. In general, sharpness refers to the clarity of detail in an image. In some implementations, the image pre-processing engine 216 is configured to increase or decrease the sharpness of the image based on the quality of the image. In general, an aspect ratio of an image refers to a proportional relationship between an image's width and height. In addition, the aspect ratio is expressed as two numbers separated by a colon. Examples of the aspect ratio may include 16:9, 1:1, 5:3, and the like. In one embodiment, the image pre-processing engine 216 is configured to change the aspect ratio of the image as per requirement.

The image pre-processing engine 216 is also configured to apply the de-skewing method to alter the skew angle of the image. In general, de-skewing is a technique or process of straightening an image that has been scanned or written crookedly. The skew angle may include a horizontal or vertical angle of the image. For example, while capturing the image of a document, it is possible that the camera is positioned at an angle such that the captured image appears to be slanting too far in one direction, or the image appears to be misaligned. De-skewing is a technique that is used to correct (i.e., alter) the angle or orientation of the image. The image pre-processing engine 216 is configured to apply the above-mentioned pre-processing operations based on the quality of the image.

Thus, the images can also be processed to correct for various image distortions. For example, the images can be processed to correct for perspective distortion. Text positioned on a plane that is not perpendicular to the camera is subject to perspective distortion, which can make text identification more difficult. Conventional perspective distortion correction techniques can be applied to the images during image pre-processing.

Once the image pre-processing operations are applied to the image to enhance the quality, the image pre-processing engine 216 is configured to pass the image to the character recognition engine 218.

The character recognition engine 218 includes a suitable logic and/or interfaces for extracting machine-readable textual data from the image. In an implementation, the machine-readable textual data may be extracted based on a character recognition engine. According to one example, the machine-readable textual data may be extracted based on an optical character recognition (OCR) engine. According to another example, the machine-readable textual data may be extracted based on an intelligent character recognition (ICR) engine.

The image may be of a scanned document, a photo of a document, text on signs or billboards, or text superimposed on an image (for example, subtitles in a video, etc.). In general, intelligent character recognition (ICR) is an advanced optical character recognition specifically designed for handwriting recognition. In addition, the ICR allows fonts and different styles of handwriting to be learned by a computer during processing to improve accuracy.

In some embodiments, the machine-readable textual data is tokenized and each of the one or more words is identified as an entity. The entity may include noun, organization, place, and the like. In general, “tokenization” is a process of splitting a string, or text into smaller units, called tokens. In one example, a text “Deliver the shipment today” may be tokenized into tokens such as “Deliver”, “the”, “shipment”, and “today”.

The machine-readable textual data includes the one or more words. The “textual data” herein refers to the data (i.e., hand-written, or printed text) actually present in the image. Additionally, the “machine-readable textual data” herein refers to the one or more words that are extracted from the image by the character recognition engine 218. For example, the image may include “Polland” as the textual data. However, the character recognition engine 218 may extract the machine-readable textual data as “9olland” based on the low accuracy of the underlying OCR engine.

In some scenarios, the one or more words may also include numerical data (e.g., integer values, decimal values, etc.) or special characters (e.g., @, !, #, $, %, etc.). In addition, each of the one or more words may belong to the same language (e.g., English, etc.). In some other scenarios, the one or more words may belong to different languages.

The character recognition engine 218 is configured to transmit the machine-readable textual data to the text processing engine 220. The text processing engine 220 is communicatively coupled with the domain lexicon database 110 and the language dictionary database 112. In one example, the domain lexicon database 110 is configured to store shipping and logistics-related keywords. In one example, the language dictionary database 112 is configured to store words belonging to a language, for example, English, Spanish, French, German, and the like. In another example, the language dictionary database 112 may be configured to store words belonging to a plurality of languages. According to an embodiment, in the event the language dictionary database 112 is configured to store words belonging to a plurality of languages, a selection option may be provided so that various languages may be selected from the plurality of languages and the words belonging to the selected languages will only be considered for matching/comparing purposes.

It is to be noted that the domain lexicon database 110 is configured to store keywords specific to a particular domain. For example, the domain may include logistics, medical, finance, advertisement technology (ad-tech), educational technology (ed-tech), and the like. Therefore, the domain lexicon database 110 is not restricted to include only the shipping and logistics-related keywords. In addition, the domain lexicon database 110 is configured to store keywords belonging to one or more domains as per the requirement (for example, the domain related to the textual data included in the image). According to an embodiment, in the event the domain lexicon database 110 is configured to store words belonging to a plurality of domains, a selection option may be provided so that various domains may be selected from the plurality of domains and the words belonging to the selected domains will only be considered for matching/comparing purposes.

The text processing engine 220 includes a suitable logic and/or interfaces for receiving the machine-readable textual data from the character recognition engine 218. The text processing engine 220 is configured to compare each of the one or more words with the words in the dataset 118 including at least one of the domain lexicon database 110 and the language dictionary database 112 to determine a first set of words and a second set of words from the one or more words. More specifically, the text processing engine 220 is configured to run a query to compare each individual word included in the one or more words with words available (i.e., already stored) in the domain lexicon database 110 and the language dictionary database 112. For each individual word that has a successful match with the dataset 118, the corresponding word is stored as the first set of words, and the remaining words that have unsuccessful matches with the dataset 118 are stored as the second set of words. In other words, the first set of words are words successfully matching with the words available in the dataset 118, and the second set of words are words with no successful matches with the words available in the dataset 118. Therefore, there is no need to perform any additional processing on the first set of words because these words are identified as the correct words.

In one embodiment, the text processing engine 220 is configured to determine the language of the machine-readable textual data (i.e., the one or more words). The one or more words may belong to a single language or multiple languages. Once the corresponding languages of the one or more words are determined, for example using machine learning based techniques, the text processing engine 220 is configured to compare each of the one or more words with the words of the determined languages only from the language dictionary database 112. The text processing engine 220, in this manner, saves a lot of computation time and resources.

For example, one or more words may belong to English and Spanish. In this scenario, the text processing engine 220 identifies the languages of the one or words in the machine-readable textual data as “English” and “Spanish”. Therefore, the text processing engine 220 is configured to compare each of the one or more words of a specific language (e.g., Spanish) with the language dictionary database 112 including Spanish words only. Similarly, the text processing engine 220 is configured to compare each of the one or more words of an English language with the language dictionary database 112 including English words only, and so on.

In this example, in another embodiment, the text processing engine 220 selects only two language dictionaries (i.e., English and Spanish) from multiple language dictionaries present in the language dictionary database 112 for comparison purposes. Further, after selecting two languages, the one or more words are compared with words present in both language dictionaries.

Similarly, the domain lexicon database 110 may include words of multiple domains. As the text processing engine 220 identifies one or more domains from the machine-readable textual data, for example using machine learning based techniques, the identified one or more domains are selected within the domain lexicon database 110 for comparison purposes. In this manner, the text processing engine 220 saves a lot of computation time and resources.

During the comparison process, the text processing engine 220 is configured to run a query to search for the one or more words of the machine-readable textual data in the dataset 118. The text processing engine 220 runs the query to determine matched words and misspelled words from among the one or more words. The “matched words” herein refer to those words that are present in at least one of the domain lexicon database 110 and the language dictionary database 112. In addition, the “misspelled words” herein refer to those words that do not match with the words available in the domain lexicon database 110 and the language dictionary database 112. Therefore, the matched words are stored as the first set of words (i.e., because the matched words are identified as the correct words since they are already available in either the domain lexicon database 110 or the language dictionary database 112) and the misspelled words are stored as the second set of words. The second set of words (i.e., the misspelled words) further undergoes additional processing steps.

The text processing engine 220 is further configured to perform correction on the misspelled words (i.e., the second set of words) to determine ‘corrected words’. However, there may be some misspelled words that are not corrected, and they are termed as ‘residual words’. For performing correction, in an embodiment, the text processing engine 220 is configured to calculate a highest similarity score for each of the second set of words (i.e., each misspelled word) with the words available in the dataset 118 (i.e., the domain lexicon database 110 and the language dictionary database 112). If the highest similarity score is at least equal (i.e., greater than or equal to) to a threshold similarity score, the text processing engine 220 is configured to detect the word from the dataset 118 corresponding to the highest similarity score as a corrected word for the respective word of the second set of words. The corrected word is further categorized as the first set of words. However, if the highest similarity score is smaller than the threshold similarity score, the text processing engine 220 considers that such misspelled word of the second set of words does not have any match in the dataset 118, and such misspelled word is tagged as a residual word. Accordingly, the matched words (i.e., the words which were present in the dataset 118) and the corrected words (i.e., words which have at least the threshold similarity with words of the dataset 118) are stored as the first set of words, and now the second set of words only includes the residual words.

For example, the highest similarity score may be calculated based on methods such as Levenshtein distance, SequenceMatcher, cosine similarity, and the like. Generally, “Levenshtein distance” is a string metric for measuring the difference between two sequences. More precisely, Levenshtein distance is a number that tells how different two strings are. In general, the higher the number, the more different the two strings are. In one example, if the Levenshtein distance between two strings (for example, string A and string B) is three, this implies that a minimum of three edits is required to convert the misspelled string A into the correct string B. In this example, the string A is the misspelled string extracted from the machine-readable textual data and the string B is the correct string stored in the dataset 118. In general, an edit may be performed in at least one of three methods including, for example, insertion of a character, deletion of a character, or replacement of a character.

Generally, “SequenceMatcher” is a class available in a python (i.e., programming language) module named “difflib”. SequenceMatcher is used to compare pairs of input sequences to determine or find the longest contiguous matching subsequence (LCS) that contains no “junk” elements. In other words, SequenceMatcher does not yield minimal edit sequences as in the case of Levenshtein distance but tends to yield matches that “look right” to people. The term “junk” herein refers to elements that the algorithm is programmed to not match (for example, elements such as blank spaces, elements in HTML tags, etc.).

Generally, “Cosine similarity” is a measure of similarity between two sequences of numbers. Additionally, these sequences are viewed as vectors in an inner product space, and the cosine similarity is defined as the cosine of the angle between them (i.e., the dot product of the vectors divided by the product of their lengths). For example, in text processing, each word is assigned a different co-ordinate and a document is represented by the vectors of the number of occurrences of each word in the document. Cosine similarity further gives a measure of how similar two documents are likely to be, in terms of their subject matter, and independently of the length of these documents.

In one implementation, the threshold similarity score (i.e., Levenshtein distance) is set as 2. However, the user 106 may modify the threshold similarity score as per the requirement. In another implementation, the threshold similarity score (i.e., cosine similarity) is set as 95. However, the user 106 may modify the threshold similarity score as per the requirement.

In another embodiment, the text processing engine 220 is configured to determine the corrected words and the residual words by initially calculating the highest domain similarity score for each of the second set of words with the words available in the domain lexicon database 110. The text processing engine 220 is further configured to determine whether the highest domain similarity score is at least equal to (i.e., greater than or equal to) a first threshold similarity score or not. Upon determining that the highest domain similarity score is at least equal to the first threshold similarity score, the text processing engine 220 is configured to detect the word from the dataset 118 corresponding to the highest domain similarity score as ‘corrected word’ for the corresponding word of the second set of words. More specifically, the corresponding word of the second set of words is replaced with the detected word based on the calculation of the highest domain similarity score.

Upon determining that the highest domain similarity score is smaller than the first threshold similarity score, the text processing engine 220 is further configured to calculate the highest language similarity score for the remaining words of the second set of words with the words available in the language dictionary database 112. The text processing engine 220 is further configured to determine whether the highest language similarity score is at least equal to (i.e., greater than or equal to) a second threshold similarity score or not. Upon determining that the highest language similarity score is at least equal to the second threshold similarity score, the text processing engine 220 is configured to detect the word corresponding to the highest language similarity score as a corrected word for the corresponding word of the second set of words. More specifically, the corresponding word is replaced with the detected word based on the calculation of the highest language similarity score.

Upon determining that the highest language similarity score is smaller than the second threshold similarity score, the text processing engine 220 is configured to tag the remaining words of the second set of words as the residual words. Therefore, after calculation of the highest domain similarity score and the highest language similarity score, the matched words and the corrected words are stored as the first set of words, and the residual words are again stored as the second set of words.

The highest domain similarity score may be calculated based on methods such as Levenshtein distance, SequenceMatcher, Cosine similarity, and the like. Similarly, the highest language similarity score may be calculated based on methods such as Levenshtein distance, SequenceMatcher, Cosine similarity, natural language processing (NLP) based techniques, and the like. In one example, the first threshold similarity score and the second threshold similarity score are set as 2 for Levenshtein distance. In some examples, the first threshold similarity score and the second threshold similarity score are set as 95 for cosine similarity. However, the user 106 may modify the first threshold similarity score and the second threshold similarity score based on the requirement.

In an embodiment, the text processing engine 220 initially calculates the highest domain similarity score and then calculates the highest language similarity score (i.e., prioritizes the calculation of the highest domain similarity score over the highest language similarity score). The highest domain similarity score is prioritized over the highest language similarity score because it is possible that the one or more words may include words specific to a particular domain. In an example scenario, if the highest language similarity score is calculated for these words, it is possible that these words may be corrected based on the language dictionary database 112, however, they must have been corrected based on the domain lexicon database 110. Thus, in this embodiment, the calculation of the highest domain similarity score is prioritized over the highest language similarity score, however, it is to be noted that the calculation of the highest domain similarity score and the highest language similarity score may be performed in parallel, or the calculation of the highest domain similarity score and the highest language similarity score may be performed in any order as per the requirement.

The text processing engine 220 is further configured to process the remaining second set of words (i.e., the residual words) to determine corresponding valid words. In an embodiment, the text processing engine 220 is configured to split at least one word of the second set of words (i.e., the residual words) into two or more words for determining a third set of words that matches with the words available in the dataset 118. More specifically, in an example, the text processing engine 220 is configured to split each of the second set of words (i.e., the residual words) into the two or more words based, at least in part, on a predefined text parsing rule. For example, any off-the-shelf word splitters can be used to split the residual words into two or more words. Generally, such word splitters split a concatenated word into two or more words.

The words may get concatenated by mistake (in case of hand-written text) or by system error (in case of printed text). According to an embodiment, the text processing engine 220 is configured to parse each residual word character by character and then concatenate the characters in an iterative manner to determine whether the concatenation of characters forming a word matches with words available in the dataset 118. After that, the text processing engine 220 is configured to compare the two or more words with the dataset 118 to determine successful matches for the two or more words in the dataset 118. In response to determining that the two or more words have successful matches in the dataset 118, the text processing engine 220 is configured to categorize the two or more words into the third set of words.

In some embodiments, the predefined text parsing rule defines a set of rules that is followed by the text processing engine 220 to split the at least one word of the second set of words. In one example, the predefined text parsing rule enables the text processing engine 220 to determine whether to split the residual word into two words or more words.

For example, let us consider that a residual word (i.e., a word in the second set of words) is “MIAMIFLORIDA”. According to one example, the text processing engine 220 can be configured to split the residual word character by character as ‘M’, ‘T’, ‘A’, ‘M’, and so on. The text processing engine 220 further starts the processing with the first character (i.e., ‘M’) and concatenates the next character to check whether the concatenation of the first character and the second character (i.e., ‘MI’) is stored in at least one of the domain lexicon database 110 and the language dictionary database 112. As ‘MI’ is not stored in the domain lexicon database 110 and the language dictionary database 112, the text processing engine 220 is configured to concatenate the next character (i.e., ‘A’ with ‘MI’) to check whether ‘MIA’ is stored in any of the domain lexicon database 110 and the language dictionary database 112. According to another example, the predefined text parsing rule can be based on any N-Gram model. In general, N-Grams are continuous sequences of words or tokens, or symbols in a document.

Similarly, the text processing engine 220 is configured to split the residual word into two, three, or more words depending on the concatenated words (i.e., the residual word). For example, if two words are concatenated together as the residual word, the text processing engine 220 is configured to split the residual word into two words. In another example, if four words are concatenated together as the residual word, the text processing engine 220 is configured to split the residual word into four words, and so on. In the above-mentioned example, the text processing engine 220 splits the residual word (i.e., “MIAMIFLORIDA”) into two words (i.e., “MIAMI” and “FLORIDA”) because both these words have a successful match in the dataset 118. Thus, the two words (i.e., “MIAMI” and “FLORIDA”) are categorized into the third set of words.

It should be noted that when the two or more words have no matches in the dataset 118, the text processing engine 220 is configured to retain the corresponding residual words (i.e., the unmatched/unchanged words even after the word split step) as the second set of words. In other words, now the ‘second set of words’ only includes the residual words which could not be split and corrected and remained unmatched or unchanged. It is to be noted that such second set of words is kept as is in the textual output along with the first and third set of words. More specifically, the text processing engine 220 is configured to generate the textual output associated with the image based at least on the first set of words, the second set of words (i.e., the unmatched residual words even after performing the word split step), and the third set of words. In one embodiment, the text processing engine 220 is configured to align the first set of words, the second set of words, and the third set of words into the textual output of the image in the same layout as per the layout of the original image. The textual output may further be displayed on a display screen of the computing device 200. More specifically, the textual output includes the first set of words, the second set of words (i.e., the unchanged residual words), and the third set of words as per the format, layout, and orientation of the original input image.

The computing device 200 also includes an input/output module 206 (hereinafter referred to as an ‘I/O module 206’) and at least one communication module, such as the communication module 208. In an embodiment, the I/O module 206 may include mechanisms configured to receive inputs from and provide outputs to a user (e.g., the user 106) of the computing device 200. To that effect, the I/O module 206 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light-emitting diode display, a thin-film transistor (TFT) display, a liquid crystal display, an active-matrix organic light-emitting diode (AMOLED) display, a microphone, a speaker, a ringer, a vibrator, and the like.

In an example, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

The communication module 208 may include communication circuitry such as for example, a transceiver circuitry including an antenna and other communication media interfaces to connect to a wired and/or wireless communication network. The communication circuitry may, in at least some embodiments, enable reception of the image from the image data source 108 including, for example, the memory 204.

In at least one embodiment, the communication module 208 is configured to receive the image including textual data in real-time. In an embodiment, the image may be scanned using a scanner connected to the computing device 200. In another embodiment, the image may be captured through a camera connected to the computing device 200. In yet another embodiment, the image may be uploaded from the memory 204 with the facilitation of the communication module 208.

The communication module 208 is configured to forward the image to the processor 202. The modules of the processor 202 in conjunction with the instructions 212 stored in the memory 204 may be configured to perform operations on the image to extract the textual output from the image intelligently i.e., perform operations such as image pre-processing, character recognition, and text pre-processing to extract information from the image intelligently.

The computing device 200 also includes a storage module 210, which may be embodied as any computer-operated hardware suitable for storing and/or retrieving data. In some embodiments, the storage module 210 is configured to store information related to various images (e.g., images may include hand-written or printed data), machine-readable textual data corresponding to various images, extracted textual output corresponding to various images, and the like. The storage module 210 may also store information related to the character recognition model type (for example, Pytesseract, OpenOCR, etc.) and the like.

The storage module 210 may include multiple storage units such as hard disks and/or solid-state disks in a redundant array of inexpensive disks (RAID) configuration. In some embodiments, the storage module 210 may include a storage area network (SAN) and/or a network-attached storage (NAS) system. In one embodiment, the storage module 210 may correspond to a distributed storage system, wherein individual databases are configured to store custom information, such as, information related to the machine-readable textual data, textual output, character recognition model, and the like. Though the storage module 210 is depicted to be integrated within the computing device 200, in at least some embodiments, the storage module 210 is external to the computing device 200 and may be accessed by the computing device 200 using a storage interface (not shown in FIG. 2). The storage interface is any component capable of providing the processor 202 with access to the storage module 210. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the storage module 210.

In one embodiment, various components of the computing device 200, such as the processor 202, the memory 204, the I/O module 206, the communication module 208, and the storage module 210 are configured to communicate with each other via or through a centralized circuit system 214. The centralized circuit system 214 may be various devices configured to, among other things, provide or enable communication between the components of the computing device 200. In certain embodiments, the centralized circuit system 214 may be a central printed circuit board (PCB) such as a motherboard, a mainboard, a system board, or a logic board. The centralized circuit system 214 may also, or alternatively, include other printed circuit assemblies (PCAs) or communication channel media.

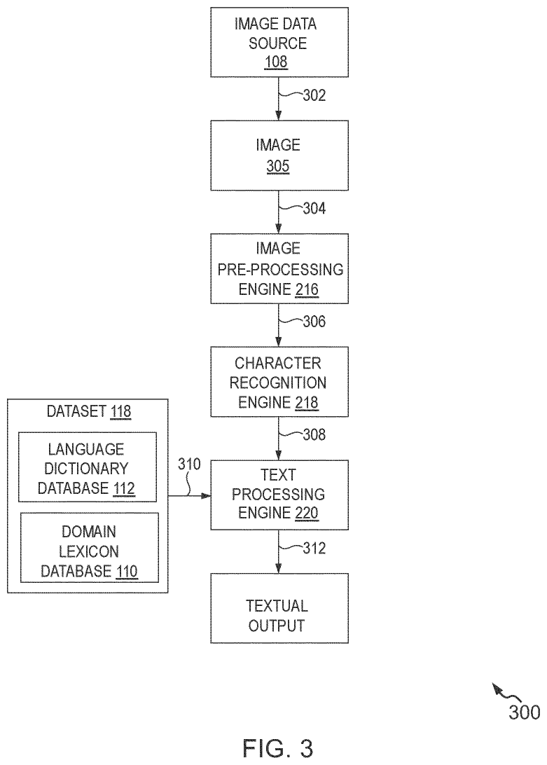

FIG. 3 is a schematic representation 300 of a process flow for performing intelligent textual output generation, in accordance with an embodiment of the present disclosure.

As explained above, an image 305 is received from the image data source 108 (see, 302). The image data source 108 may include the local directory of the computing device 104 of FIG. 1, third-party external directory accessed on the computing device 104 of FIG. 1 via the internet (e.g., the network 114 of FIG. 1), and the like. The image data source 108 may also include the peripheral devices 126 including, for example, camera, scanner, and the like. In such a scenario, a communication module (e.g., the communication module 208 of FIG. 2) is configured to receive the image 305 from the image data source 108.

In an example, the image data source 108 may include a scanner used to scan a paper document, and then the image 305 refers to the scanned image of the paper document. In another example, the image data source 108 may include a camera used to capture an image of a paper document and then the image 305 refers to the captured image of the paper document. In yet another example, the image data source 108 may refer to a non-volatile memory that stores the image 305. The image 305 includes the textual data. In some embodiments, the image 305 may include complete textual data (e.g., in the case of an invoice document), or the image 305 may include partial textual data (e.g., in case of captions displayed in a video frame).

Further, the image pre-processing engine 216 is configured to receive the image 305 including the textual data (see, 304). In some embodiments, a portion of the image 305 may include at least partially obscured (i.e., unclear, or blurry) text. Furthermore, the image pre-processing engine 216 is configured to perform at least one image pre-processing operation over the image 305 to enhance its quality. More specifically, the image pre-processing engine 216 is configured to perform the at least one image pre-processing operation over the image to increase the readability of the textual data of the image 305.

In an embodiment, the image pre-processing engine 216 may perform only one image pre-processing operation over the image 305. In another embodiment, the image pre-processing engine 216 may perform any two image pre-processing operations over the image 305. In yet another embodiment, the image pre-processing engine 216 may perform three image pre-processing operations over the image 305. In some embodiments, the image pre-processing engine 216 analyzes the quality of the image 305 to determine the number of image pre-processing operations required to enhance the quality of the image 305.

The image pre-processing engine 216 is further configured to pass the image 305 to the character recognition engine 218 (see, 306). The character recognition engine 218 is configured to extract the machine-readable textual data from the image 305. The character recognition engine 218 is configured to apply optical character recognition (OCR) engines including, for example, Pytesseract, OpenOCR, and the like, to extract the machine-readable textual data from the image 305. The machine-readable textual data includes the one or more words. The machine-readable textual data may also include numerical data, special characters, symbols, and the like.

Furthermore, the character recognition engine 218 is configured to pass the machine-readable textual data to the text processing engine 220 (see, 308). The text processing engine 220 is configured to perform the text processing operations over the machine-readable textual data to extract information intelligently from the machine-readable textual data. More specifically, the text processing engine 220 is configured to perform the intelligent text extraction from the machine-readable textual data. The text processing engine 220 may utilize the domain lexicon database 110 and the language dictionary database 112 to perform the text extraction intelligently (see, 310). The text processing engine 220 further displays the textual output post-application of the text processing operations over the machine-readable textual data (see, 312). A detailed explanation of extraction of information (i.e., the textual output) from the machine-readable textual data is explained herein with reference to FIG. 2, and therefore, it is not reiterated for the sake of brevity. The extracted information (i.e., the textual output) may further be used for one or more downstream tasks (e.g., sentiment analysis, etc.).

In one example, the performance of the text extraction application 116 is evaluated for various images with different levels of image quality. The performance metrics for the text extraction application 116 is illustrated below in Table 1:

TABLE 1
Performance metrics for text extraction
application for various images

| | Without | With image pre-processing |
|---|---|---|
| Image | text-processing | operations, character recognition, |
| Quality | operations | and text processing |
| b7 | 81.8 | 85.4 |
| b7g | 49.9 | 59.5 |
| b13 | 51.9 | 62.8 |
| b13g | 9.1 | 14.2 |
| b17 | 25.9 | 41.8 |
| b17g | 2.9 | 7.6 |
| Average | 36.9 | 45.2 |

Here, bN refers to the blurring of an image taking into consideration a kernel of size N×N. Additionally, bNg refers to the inclusion of greyness to bN image. For example, b7 refers to the blurring of an image taking into consideration a kernel of size 7×7. Additionally, b7g refers to the inclusion of greyness to a b7 image. As shown in Table 1, the performance of the text extraction application 116 is greater (e.g., average value 45.2) when the text extraction application 116 applies the image pre-processing operations over the image prior to extracting the machine-readable textual data and applies text processing operations over the machine-readable textual data.

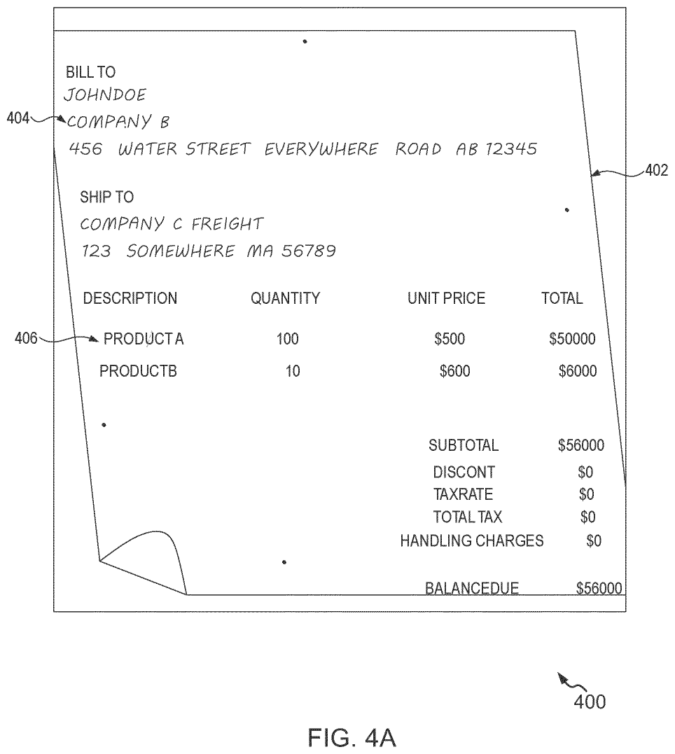

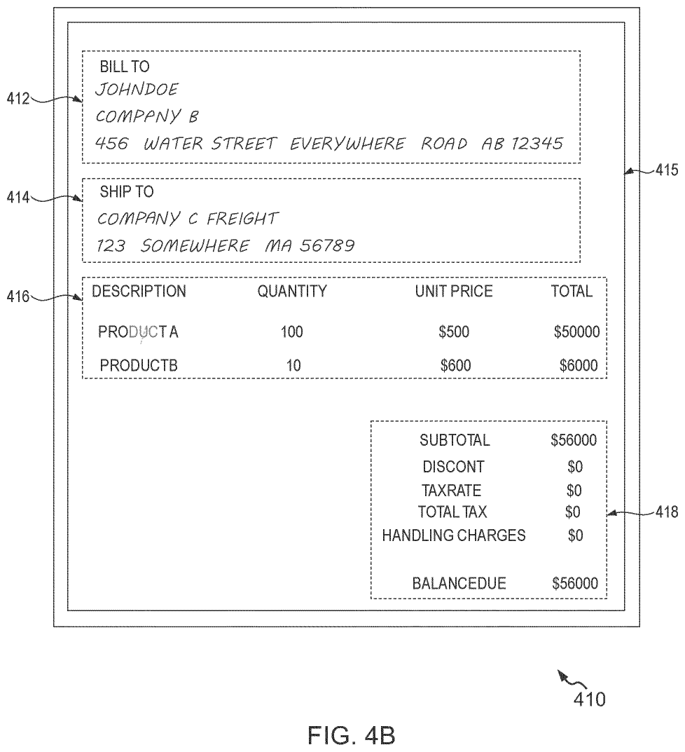

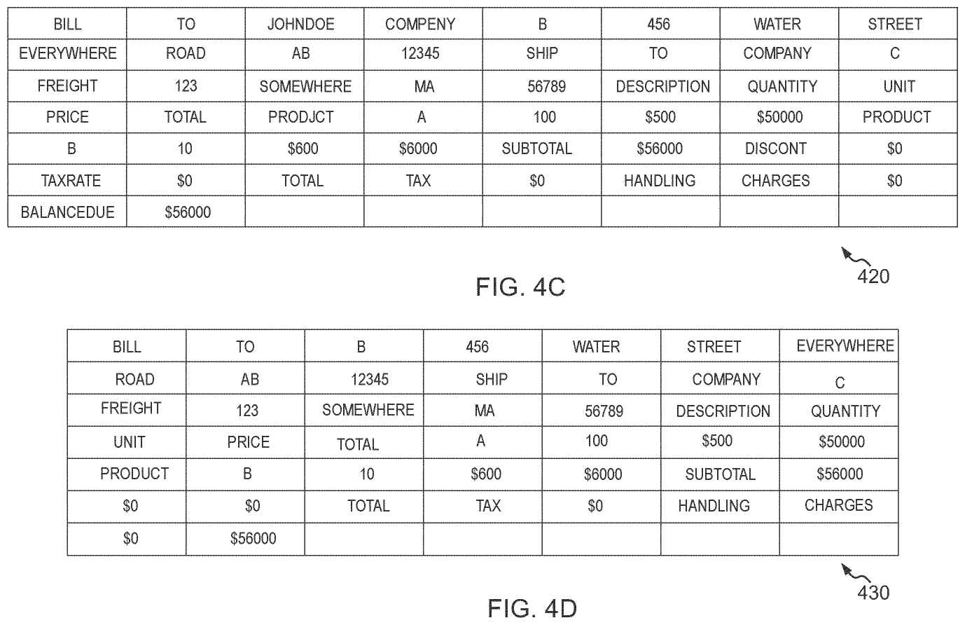

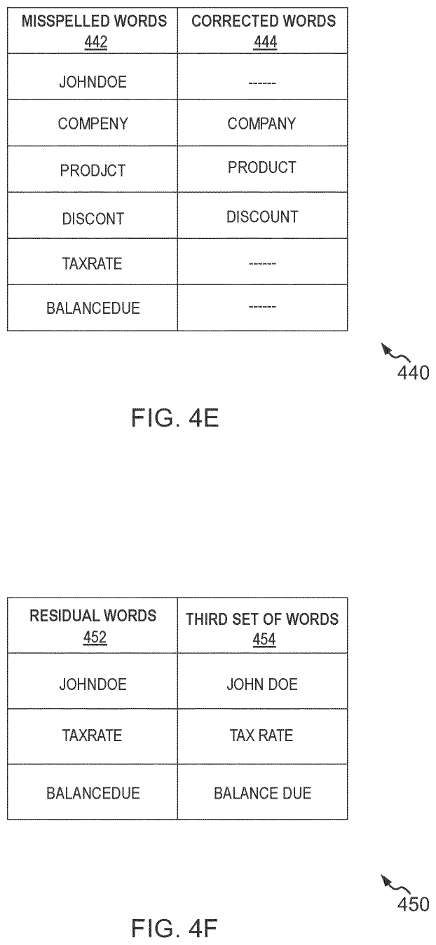

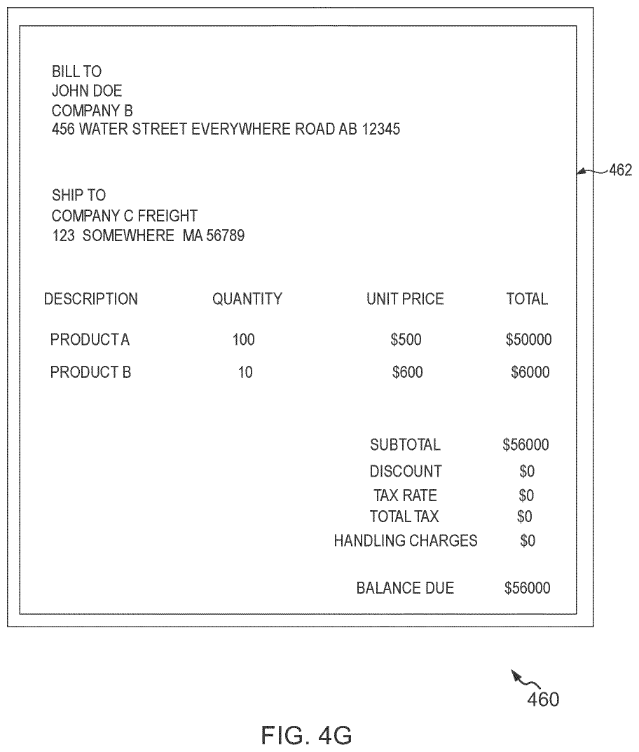

FIGS. 4A-4G, collectively, represent example representations for performing image pre-processing, character recognition, and text processing on the image, in accordance with an embodiment of the present disclosure.

FIG. 4A illustrates an exemplary representation 400 of an image 402 of a sample invoice, in accordance with an embodiment of the present disclosure. As explained above, the processor 202 is configured to receive an image 402 of the sample invoice. The sample invoice may be associated with an organization ‘A’ (e.g., shipping company). In an example, the sample invoice is scanned through a scanner and the scanned image (i.e., the image 402) is uploaded to the text extraction application 116. In another example, an image of the sample invoice may be captured using a camera and then the captured image (i.e., the image 402) is uploaded to the text extraction application 116. The user 106 may access the user interfaces (UIs) of the text extraction application 116 to upload the image 402 in the text extraction application 116.

In one example, the image 402 may include some hand-written text (see, 404). The image 402 may also include obscured text (i.e., unclear or blurry text) (see, 406). Therefore, the processor 202 is configured to apply at least one image pre-processing operation over the image 402 to enhance the quality of the image 402. For example, the processor 202 is configured to apply the adaptive thresholding method to eliminate grey areas from the image 402. Additionally, or alternatively, the processor 202 is configured to apply the image enhancement method to update the one or more image parameters of the image 402. The processor 202 may also, additionally or alternatively, apply the de-skewing method to alter the skew angle of the image. It should be noted that the processor 202 is configured to apply at least one or none of the image pre-processing operations over the image 402 based on the quality of the image 402.

FIG. 4B illustrates an exemplary representation 410 of an image 415 obtained after performing the image pre-processing operations, in accordance with an embodiment of the present disclosure. The image 415 is similar to the image 402, however, the image 415 illustratively represents an image obtained after application of at least one image pre-processing operation over the image 402. The image 415 has increased quality and readability of the textual data that was originally present in the image 402.

As shown in FIG. 4B, the image 415 includes a first section (see, 412) that depicts the “bill to” address in the sample invoice. The “bill to” address herein refers to the name of the company along with the address where the invoice is shared. In addition, the image 415 includes a second section (see, 414) that depicts the “ship to” address in the sample invoice. The “ship to” address herein refers to the name of the company along with the address where the actual shipment (e.g., goods, products, services, etc.) is shared. The image 415 further includes a third section (see, 416) that depicts a list of items (e.g., goods, products, services, etc.) provided along with the cost per unit (i.e., cost of a single unit of a particular item) and the final cost of each item based on the quantity. Furthermore, the image 415 includes a fourth section (see, 418) that depicts the total amount payable to the sender of the shipment after deduction of any discount (if applicable) and the addition of suitable taxes based on the country. The fourth section depicts the total ‘Balance due’ (in suitable currency) that is to be paid to the sender of the shipment.

As explained above, the processor 202 is configured to extract the machine-readable textual data from the image 415. In a non-limiting example, the processor 202 is configured to extract the machine-readable text from the image 415 based on OCR engines already known in the art. In another embodiment, the processor 202 is configured to extract the machine-readable textual data from the image 415 based on ICR engines already known in the art.

It is to be noted that the accuracy of the underlying OCR engine or the underlying ICR engine used to extract the machine-readable textual data may not be 100%. Therefore, the “machine-readable textual data” herein refers to the data that has been extracted from the image 415 based on the underlying OCR engine or the ICR engine. In an example, the hand-written text “company” displayed in the first section is not interpreted properly by the underlying OCR engine or the ICR engine. As a result, the hand-written text “company” included in the first section is interpreted as “compeny”. Similarly, the obscured text ‘Product A’ has been extracted as ‘Prodjct A’ by the character recognition engine. These errors occurred due to less accuracy of the underlying character recognition engine (i.e., OCR engine, ICR engine, etc.). As explained above, the machine-readable textual data includes the one or more words extracted after the application of the character recognition engine.

FIG. 4C illustrates a table 420 depicting one or more words extracted from the image 415, in accordance with an embodiment of the present disclosure. The table 420 includes the one or more words (i.e., the machine-readable textual data) that are extracted from the image 415. In an embodiment, the one or more words are extracted from the image 415 based on the execution of the character recognition engines already known in the art. In another embodiment, the one or more words are extracted from the image 415 based on the execution of the OCR engines already known in the art. In yet another embodiment, the one or more words are extracted from the image 415 based on the execution of the ICR engines already known in the art.

The processor 202 is further configured to compare each of the one or more words with the dataset 118 (i.e., the domain lexicon database 110 and the language dictionary database 112) to determine the first set of words and the second set of words from the one or more words. In the present example, the domain lexicon database 110 may store customized domain words (for example, names of frequent customers of the organization ‘A’ and logistics-related terms) and may be updated based at least on invoice history of the organization ‘A’ and manual intervention.

As explained above, the first set of words corresponds to the words successfully matching with words stored in the dataset 118. In addition, the second set of words represents the words that do not successfully match with the dataset 118.

FIG. 4D illustrates a table 430 depicting a first set of words from the one or more words extracted from the image 415, in accordance with an embodiment of the present disclosure. The table 430 depicts a list of words that is successfully matched in the dataset 118 and therefore, these words are termed as the first set of words. For example, the first set of words includes “Bill”, “To”, and the like. The complete list of the first set of words extracted from the image 415 is illustrated in the table 430.

As explained above, the second set of words includes the misspelled words (i.e., words with no successful matching with the dataset 118). The misspelled words include words that are incorrectly extracted due to the poor accuracy of the underlying character recognition engine. For example, with reference to FIG. 1B, the hand-written text “company” included in the first section has been extracted as “compeny” due to the poor accuracy of the underlying character recognition engine used for the text extraction. Similarly, the obscured text ‘Product A’ has been extracted as ‘Prodjct A’ by the character recognition engine. The misspelled words may also be printed or typed incorrectly (in the case of printed text) or written incorrectly (in the case of hand-written text). The processor 202 is then configured to correct the misspelled words based on the highest similarity score to determine the corrected words for some of the misspelled words, and the misspelled words for which corrected words are not obtained are termed as “residual words”. In one embodiment, the highest similarity score is calculated based on a comparison of each misspelled word with words stored in the dataset 118.

In some embodiments, the processor 202 is initially configured to correct at least some of the second set of words (i.e., the misspelled words) based on the highest domain similarity score. Based on this operation, some words of the second set of words can be corrected (termed as ‘corrected words’) and some words may not be corrected (termed as ‘residual words’). The highest domain similarity score is calculated based on a comparison of each misspelled word with words stored in the domain lexicon database 110. In case the misspelled words are not corrected based on the highest domain similarity score, the processor 202 is further configured to correct the misspelled words based on the highest language similarity score to determine the corrected words and the residual words. Additionally, the highest language similarity score is calculated based on a comparison of each misspelled word with words stored in the language dictionary database 112. A detailed explanation of the correction of the misspelled words to determine the corrected words and the residual words is already explained with reference to FIG. 2, and therefore, it is not reiterated for the sake of brevity.

FIG. 4E illustrates a table 440 depicting misspelled words and corresponding corrected words, in accordance with an embodiment of the present disclosure.

The table 440 includes the misspelled words (i.e., “JohnDoe”, “Compeny”, “Prodjct”, “Discont”, “Taxrate”, and “Balancedue”) (see, 442). The misspelled words correspond to those words that are not successfully matched with the words stored in the dataset 118. As explained earlier, the processor 202 is configured to correct the misspelled words based on the calculation of the highest similarity score with words present in the dataset 118 (both of the domain or language databases). In another embodiment, the processor 202 is configured to correct the misspelled words based on a calculation of the highest domain similarity score and comparison of the score with a first threshold score, and also if required, the calculation of the highest language similarity score and comparison of this score with a second threshold score.

In the illustrated example, the processor 202 is configured to correct the misspelled word “JohnDoe”. The processor 202 is configured to calculate the highest similarity score. However, the highest similarity score is less than the threshold similarity score, and therefore, the misspelled word “JohnDoe” is termed as the residual word. In some embodiments, the processor 202 is configured to calculate the highest domain similarity score and the highest language similarity score. Since the highest domain similarity score is less than the first threshold similarity score and the highest language similarity score is less than the second threshold similarity score, therefore, the misspelled word “JohnDoe” is termed as the residual word.

Further, in the illustrated example of FIG. 4E, the processor 202 is configured to correct the misspelled word “Compeny”. The processor 202 is configured to calculate the highest similarity score based on words available in the dataset 118. In one example, the misspelled word “Compeny” finds the highest similarity with the word “Company” available in the language dictionary database 112. Hence, the processor 202 is configured to replace the misspelled word “Compeny” with the word “Company” based at least on the highest domain similarity score or the highest language similarity score. In another example, the single character ‘e’ is replaced with ‘a’ based on Levenshtein distance, and the misspelled word “Compeny” is replaced with the word “Company”. The word “Company” is further categorized as the first set of words. Similarly, the word “Prodjct” is corrected to “Product”.

In this manner, the misspelled words (see, 442) are corrected to their corresponding corrected words (see, 444). The corrected words that are left blank in the table 440 are the residual words. The “residual words” herein refers to those words that cannot be corrected based on the highest similarity score, or the highest domain similarity score and the highest language similarity score. It should be noted that all the corrected words are categorized as the first set of words and only these residual words are now the current second set of words.

FIG. 4F illustrates a table 450 depicting residual words and corresponding corrected words, in accordance with an embodiment of the present disclosure.

As explained above, the processor 202 is further configured to correct the current second set of words i.e., the residual words. These second set of words (the residual words) are the words that are left unmatched even after calculation of the highest similarity score, or the highest domain similarity score and the highest language similarity score. As explained above, the processor 202 is further configured to split the second set of words (i.e., residual words) into two or more words based, at least in part, on the predefined text parsing rule. In one embodiment, the predefined text parsing rule defines whether the residual word is going to be split into two, three, or more words.

For example, consider a word from the second set of words (or the residual words) as “JohnDoe”. The residual word “JohnDoe” has no successful matching in the dataset 118. Additionally, the residual word “JohnDoe” cannot be replaced with a correct word based on the calculation of the highest similarity score, the highest domain similarity score, and the highest language similarity score. Therefore, the residual word “JohnDoe” is further split based on the text parsing rule.

The processor 202 is configured to split the residual word character by character and then concatenate the characters in an iterative manner to check whether the concatenation of the characters forms a word that matches with the words already stored in the dataset 118. For example, the processor is configured to split the residual word “JohnDoe” character by character as ‘J’, ‘o’, ‘h’, ‘n’, ‘D’, ‘o’, and ‘e’. The processor is further configured to concatenate the characters in an iterative manner and further check whether the concatenation of the characters successfully matches with any of the words already stored in the dataset 118.

For example, the processor 202 concatenates the first character (i.e., ‘J’) with the subsequent character (i.e., ‘o’) to check whether the concatenation of the first character and the second character (i.e., ‘Jo’) matches with the words already stored in the dataset 118. In this example, since ‘Jo’ is not stored in the dataset 118, the processor 202 is further configured to concatenate the next character (i.e., ‘h’) with the already concatenated string (i.e., ‘Jo’) to form ‘Joh’. Furthermore, the processor 202 is configured to determine whether ‘Joh’ matches with the words already stored in the dataset 118. Since ‘Joh’ again does not match successfully with the words already stored in the dataset 118, the processor is again configured to concatenate the next character (i.e., ‘n’) with the already concatenated string (i.e., ‘Joh’) to form ‘John’. Since ‘John’ is a name that may match successfully in the language dictionary database 112 or the domain lexicon database 110, the processor 202 is configured to consider the word ‘John’ as one word and further check for the remaining characters in an iterative manner. It is to be noted that the processor 202 may determine one, two, or more words from the remaining characters and therefore, there may be any number of words that may be determined from the residual word.

In our example of the word ‘JohnDoe’, the processor 202 is configured to determine one more word (i.e., ‘Doe’) as the word that matches with the language dictionary dataset 118. Therefore, the words ‘John’ and ‘Doe’ are now categorized as the third set of words. In this manner, the processor 202 is configured to determine the third set of words (i.e., correct words) for the at least one word of the second set of words (i.e., residual words). More specifically, the “residual words” herein refer to the concatenated words in which two or more words have been concatenated together due to some error. Additionally, the processor 202 is configured to split the concatenated word into two or more correct words. The table 450 includes a list of the residual words (see, 452) and the third set of words (see, 454). In case any word of the second set of words (i.e., residual word) is left uncorrected even after the splitting step, that particular word may remain as is in the textual output associated with the image 415. It should be noted that after the splitting operation, some of the second set of words (i.e., the residual words) are corrected to the ‘third set of words’, and some words which are not corrected only remain as the final ‘second set of words’. Hence, in this manner, the ‘second set of words’ finally includes only the remaining words that are unchanged even after the splitting operations.

FIG. 4G illustrates an exemplary representation 460 of a textual output 462 of the image 415 after execution of the text processing operations over the image 415, in accordance with an embodiment of the present disclosure. In an embodiment, the textual output 462 may be displayed on a display screen of the computing device 200 of FIG. 2. The textual output 462 includes the first set of words, the third set of words, and the second set of words (i.e., the “unchanged words” which could not be corrected even after splitting operation) if any. The term “unchanged words” herein refers to final second set of words i.e., those words that are not corrected even after calculation of the highest similarity score, the highest domain similarity score, the highest language similarity score, and splitting the residual words. Such words are displayed unchanged in the final textual output 462 associated with the image 415. With reference to illustrated example image in FIGS. 4A-4B, there are no unchanged words and therefore, the textual output 462 includes only the first set of words and the third set of words.

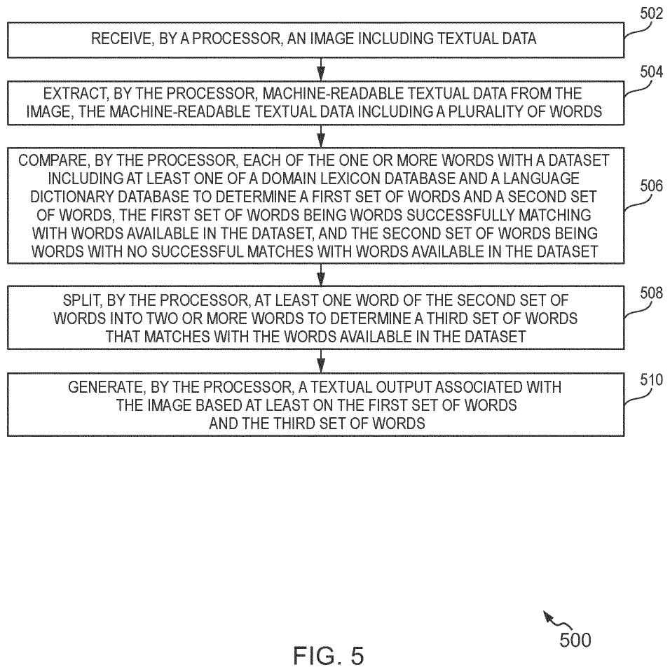

FIG. 5 is a process flow chart of a computer-implemented method 500 for accurately generating textual outputs from images, in accordance with an embodiment of the present disclosure. The method 500 depicted in the flow chart may be executed by the computing device 200. Operations of the flow chart of method 500, and combinations of operation in the flow chart of method 500, may be implemented by, for example, hardware, firmware, a processor (e.g., the processor 202), circuitry, and/or a different device associated with the execution of software that includes one or more computer program instructions. It is noted that the operations of the method 500 can be described and/or practiced by using a system other than the computing device 200. The method 500 starts at operation 502.

At operation 502, the method 500 includes receiving, by the processor 202, the image including textual data.

At operation 504, the method 500 includes extracting, by the processor 202, the machine-readable textual data from the image. The machine-readable textual data includes the one or more words.

At operation 506, the method 500 includes comparing, by the processor 202, each of the one or more words with the dataset 118 including at least one of the domain lexicon database 110 and the language dictionary database 112 to determine the first set of words and the second set of words. The first set of words is words successfully matching with the words available in the dataset 118, and the second set of words is words with no successful matches with the words available in the dataset 118.

At operation 508, the method 500 includes splitting, by the processor 202, at least one of the second set of words into the two or more words to determine the third set of words that matches with the words available in the dataset 118.

At operation 510, the method 500 includes generating, by the processor 202, the textual output associated with the image based at least on the first set of words and the third set of words.

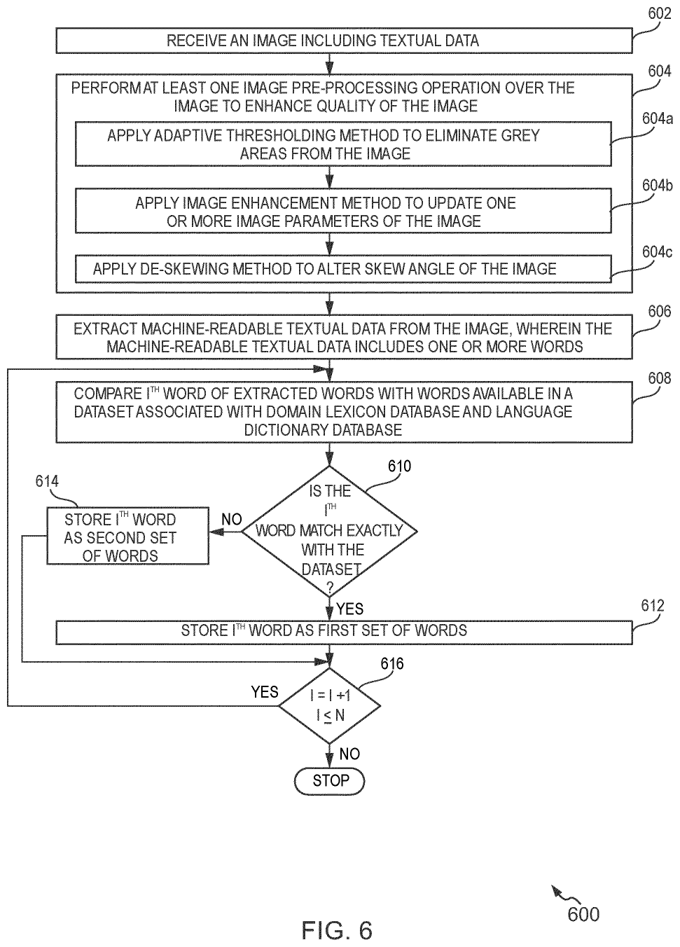

FIG. 6 represents a data flow diagram representation 600 for extracting words from an image and determining a first set of words and a second set of words from the extracted words, in accordance with an embodiment of the present disclosure. It should be appreciated that each operation explained in the representation 600 is performed by the text extraction application 116. The sequence of operations of the representation 600 may not be necessarily executed in the same order as they are presented. Further, one or more operations may be grouped together and performed in form of a single step, or one operation may have several sub-steps that may be performed in parallel or in a sequential manner. It is to be noted that to explain the process steps of FIG. 6, references may be made to system elements of FIGS. 1A-1B and FIG. 2.

At 602, the text extraction application 116 receives an image including textual data. In one example, the text extraction application 116 is installed in a mobile phone having a camera. In addition, a user of the mobile phone may launch the text extraction application 116 in the mobile phone to scan a document using the camera of the mobile phone, or the user may capture an image of the document using the camera of the mobile phone. In another example, the image may already be stored in the local directory (e.g., external memory) of the mobile phone.

At 604, the text extraction application 116 performs at least one image pre-processing operation over the image to enhance the quality of the image. Additionally, the image pre-processing operation is performed over the image to enhance the quality or increase the readability of the textual data of the image. The image pre-processing operations are performed prior to performing text extraction from the image.

The image pre-processing operation may be any combination of operations 604a to 604c. At 604a, the text extraction application 116 applies the adaptive thresholding method to eliminate grey areas from the image or increase the brightness of the image. At 604b, the text extraction application 116 applies the image enhancement method to update one or more image parameters of the image. The one or more image parameters may include, but are not limited to, at least one of: (a) brightness, (b) contrast, (c) sharpness, and (d) aspect ratio. The text extraction application 116 may automatically update any or all of the one or more image parameters based on the quality of the image. At 604c, the text extraction application 116 applies the de-skewing method to alter the skew angle of the image. For example, it is possible that a document is not scanned properly, which leads to the angle of the scanned image stretching more towards one direction or the orientation of the scanned image becoming incorrect. In such cases, the text extraction application 116 is configured to apply the de-skewing method to alter the skew angle and the orientation of the image.

At 606, the text extraction application 116 extracts machine-readable textual data from the image based on a character recognition engine. The machine-readable textual data may include the one or more words. The machine-readable textual data may also include numerical data, special characters, symbols, and the like. Based on the number of extracted words (i.e., one or more words) denoted as ‘N’, the text extraction application 116 runs a plurality of steps in an iterative manner for each of the one or more words.

At 608, the text extraction application 116 may compare an i^{th} word of the extracted words with the words stored or available in the dataset 118 associated with the domain lexicon database 110 and the language dictionary database 112. Herein, ‘i’ is a positive integer, and i^{th} is less than or equal to a number (denoted as ‘N’) of the one or more words. Initially, a word associated with i^{th} index value equal to the lowest value (e.g., first word) is selected.

At 610, the text extraction application 116 identifies whether the i^{th} word matches exactly with at least one of the words available in the dataset 118 or not.

When the text extraction application 116 identifies that the i^{th} word matches exactly with at least one of the words available in the dataset 118, at 612, the text extraction application stores the i^{th} word into a first storage portion (associated with the first set of words) of the memory 204. In other words, the text extraction application 116 marks or assigns the i^{th} word in the first set of words. In particular, the first set of words is words successfully matching with the words available in the dataset 118.

When the text extraction application 116 identifies that the i^{th} word does not match exactly with at least one of the words available in the dataset 118, at 614, the text extraction application stores i^{th} word into a second storage portion (associated with second set of words) of the memory 204. In other words, the text extraction application 116 marks or assigns the i^{th} word in the second set of words. In particular, the second set of words is words with no successful matching with the words available in the dataset 118.

At 616, the text extraction application 116 increments the i^{th} value (i→i+1) and checks the i^{th} value against the number of the extracted words. If the i^{th} value is less than or equal to ‘N’, the process goes back to the step 608, otherwise, the process ends. In other words, the text extraction application 116 selects the next word from the one or more words to compare the next word with the words available in the dataset 118.

After identifying the second set of words from the one or more words, the text extraction application 116 may perform additional text processing for the second set of words to improve the quality of the text extraction process.

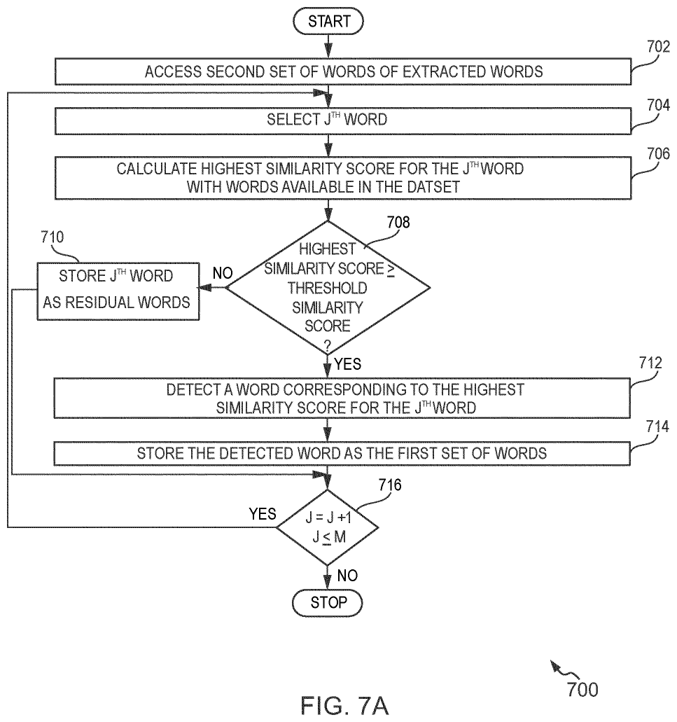

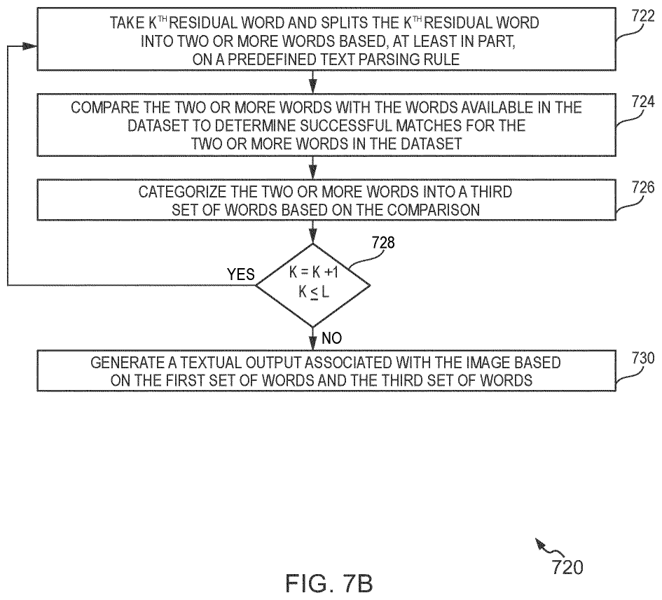

FIG. 7A (in conjunction with FIG. 6) is a simplified data flow diagram representation 700 for performing the additional text processing for the second set of words, in accordance with an embodiment of the present disclosure. It should be appreciated that each operation explained in the representation 700 is performed by the text extraction application 116. The sequence of operations of the representation 700 may not be necessarily executed in the same order as they are presented. Further, one or more operations may be grouped and performed in form of a single step, or one operation may have several sub-steps that may be performed in parallel or a sequential manner. It is to be noted that to explain the process steps of FIG. 7A, references may be made to system elements of FIGS. 1A-1B and 2.

At 702, the text extraction application 116 accesses a second set of words from the second storage portion of the memory 204.

At 704, the text extraction application 116 takes j^{th} word (i.e., misspelled word) from the second set of words. Initially, a word associated with j^{th} index value equal to a lowest value (e.g., 1) is selected.

At 706, the text extraction application 116 calculates a highest similarity score for the j^{th} word with words available in the dataset 118 (including the domain lexicon database 110 and the language dictionary database 112). More specifically, the text extraction application 116 identifies the highest similarity score for the j^{th} word by computing similarity scores of the j^{th} word with words available in the dataset 118.

At 708, the text extraction application 116 checks whether the highest similarity score is at least equal (i.e., greater than or equal) to a threshold similarity score or not.

When the highest similarity score is not greater than or equal to the threshold similarity score, at 710, the text extraction application 116 stores the j^{th} word as a residual word and performs operations described with reference to FIG. 7B.

When the highest similarity score is greater than or equal to the threshold similarity score, at 712, the text extraction application 116 detects a word (i.e., corrected word found in the dataset 118 for the j^{th} word) corresponding to the highest similarity score as a corrected word for the j^{th} word.

Further, at 714, the text extraction application 116 stores the detected word as the first set of words. Hence, in the textual output, the text extraction application 116 replaces the j^{th} word with the detected word.

At 716, the text extraction application 116 increments the j^{th} value (j→j+1) and checks the j^{th} value against a number (denoted as ‘M’) of the second set of words. If the j^{th} value is less than or equal to ‘M’, the process goes back to the step 704, otherwise, the process ends. In other words, the text extraction application 116 selects the next word from the second set of words to calculate a highest similarity score for the next word with the words available in the dataset 118.

FIG. 7B (in conjunction with the FIG. 7A) is a simplified data flow diagram representation 720 for splitting a group of the second set of words (i.e., residual words) to determine corrected words and generating the textual output of the image, in accordance with an embodiment of the present disclosure. It should be appreciated that each operation explained in the representation 720 is performed by the text extraction application 116. The sequence of operations of the representation 720 may not be necessarily executed in the same order as they are presented. Further, one or more operations may be grouped and performed in form of a single step, or one operation may have several sub-steps that may be performed in parallel or a sequential manner. It is to be noted that to explain the process steps of FIG. 7B, references may be made to system elements of FIGS. 1A-1B and 2.

At 722, the text extraction application 116 takes a k^{th} residual word and splits the k^{th} residual word into two or more words based, at least in part, on a predefined text parsing rule. It is to be noted that the text extraction application 116 may split the k^{th} residual word into any number of words based on the predefined text parsing rule. In an example, the operation 722 can be initialized by selecting (K=1) the first word of a total of ‘L’ residual words, where ‘L’ is a positive integral number.

At 724, the text extraction application 116 compares the two or more words with the words available in the dataset 118 to determine successful matches for the two or more words in the dataset 118.

At 726, text extraction application 116 categorizes the two or more words into a third set of words based on the comparison. More particularly, when the two or more words have successful matches with the words available in the dataset 118, the two or more words are included in the third set of words. When the two or more words do not have a successful match with the words available in the dataset 118, the k^{th} residual word is kept unchanged in textual output.

At 728, the text extraction application 116 increments the k^{th} value (k→k+1) and checks the k^{th} value against a number (denoted as ‘L’) of the residual words. If the k^{th} value is less than or equal to ‘L’, the process goes back to the step 722, otherwise, the process moves to step 730.

At the step 730, the text extraction application 116 generates the textual output associated with the image based on the first set of words, the third set of words, and the unchanged words. In particular, the text extraction application 116 inserts the third set of words in place of corresponding residual words in the textual output associated with the image. The “textual output” herein refers to the final output generated after performing the text processing operations on the extracted machine-readable textual data.

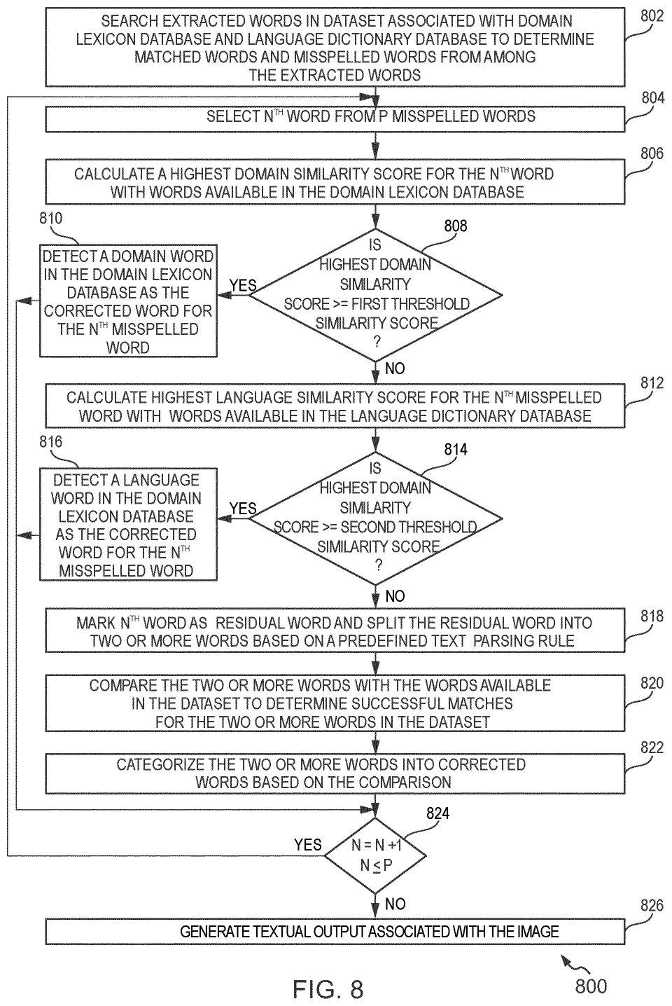

FIG. 8 represents a simplified data flow diagram representation 800 for accurately generating textual outputs from images, in accordance with another embodiment of the present disclosure. It should be appreciated that each operation explained in the representation 800 is performed by the text extraction application 116. The sequence of operations of the representation 800 may not be necessarily executed in the same order as they are presented. Further, one or more operations may be grouped and performed in form of a single step, or one operation may have several sub-steps that may be performed in parallel or in a sequential manner. It is to be noted that to explain the process steps of FIG. 8, references may be made to system elements of FIGS. 1A-1B and FIG. 2.

As mentioned earlier, the text extraction application 116 extracts one or more words from an image based on a character recognition engine. To improve the efficiency of the text extraction process, the text extraction application 116 performs additional text processing over the extracted words.

At 802, the text extraction application 116 searches the extracted words in the dataset 118 associated with a domain lexicon database 110 and a language dictionary database 112 to determine matched words (i.e., first set of words) and misspelled words (i.e., second set of words) from among the extracted words. In one example, the text extraction application 116 performs an exact string matching to determine the matched words and the misspelled words.

To perform correction on the misspelled words, the text extraction application 116 performs a threshold matching with words available in the dataset 118 associated with the domain lexicon database 110 and the language dictionary database 112.

At 804, the text extraction application 116 selects an n^{th} word from the misspelled words. Herein, ‘n’ is a positive integral value, and ‘n’ is less than or equal to a number (denoted as ‘P’) of the misspelled words. In an example, the operation 804 may be initialized by selecting a word associated with n^{th} index value equal to a lowest value (e.g., 1).

At 806, the text extraction application 116 calculates a highest domain similarity score for the n^{th} word with words available in the domain lexicon database 110. More specifically, the text extraction application 116 is configured to compare the n^{th} word with the words available in the domain lexicon database 110 and calculate the highest domain similarity score based on the comparison.

At 808, the text extraction application 116 checks whether the highest domain similarity score for n^{th} word is at least equal (i.e., greater than or equal) to a first threshold similarity score.

When the highest domain similarity score is greater than or equal to the first threshold similarity score, at 810, the text extraction application 116 detects a domain word (i.e., matched word found in the domain lexicon database 110) corresponding to the highest domain similarity score as the “corrected word” for the n^{th} misspelled word.

When the highest domain similarity score is not greater than or equal to the first threshold similarity score, at 812, the text extraction application 116 calculates the highest language similarity score for the n^{th} misspelled word with words available in the language dictionary database 112. More specifically, the text extraction application 116 compares the n^{th} misspelled word with the words available in the language dictionary database 112 and calculates the highest language similarity score based on the comparison.

At 814, the text extraction application 116 checks whether the highest language similarity score for the n^{th} word is at least equal (i.e., greater than or equal) to a second threshold similarity score.

When the highest language similarity score is greater than or equal to the second threshold similarity score, at 816, the text extraction application 116 detects a language word (i.e., matched word found in the language dictionary database 112) corresponding to the highest language similarity score as the corrected word for the n^{th} misspelled word.

When the highest language similarity score is not greater than or equal to the second threshold similarity score, at 818, the text extraction application 116 marks the n^{th} word as residual word and splits the residual word into two or more words based, at least in part, on a predefined text parsing rule.

At 820, the text extraction application 116 compares the two or more words with the words available in the dataset 118 associated with the domain lexicon database 110 and the language dictionary database 112 to determine successful matches for the two or more words in the dataset 118.

At 822, text extraction application 116 categorizes the two or more words into corrected words based on the comparison. More particularly, when the two or more words have successful matches with the words available in the dataset 118, the two or more words are included in the corrected words and are inserted in the place of the n^{th} word in a textual output. When the two or more words do not have a successful match with the words available in the dataset 118, the n^{th} word is kept unchanged in the textual output.

At 824, the text extraction application 116 increments the n^{th} value (n→n+1) and checks the n^{th} value against a number (denoted as ‘P’) of the misspelled words. If the n^{th} value is less than or equal to ‘P’, the process goes back to the step 804, otherwise, the process moves to step 826.

At the step 826, the text extraction application 116 generates a textual output associated with the image based on the matched words, corrected words and the unchanged words. In particular, the text extraction application 116 inserts corrected words in place of corresponding misspelled words in the textual output associated with the image.

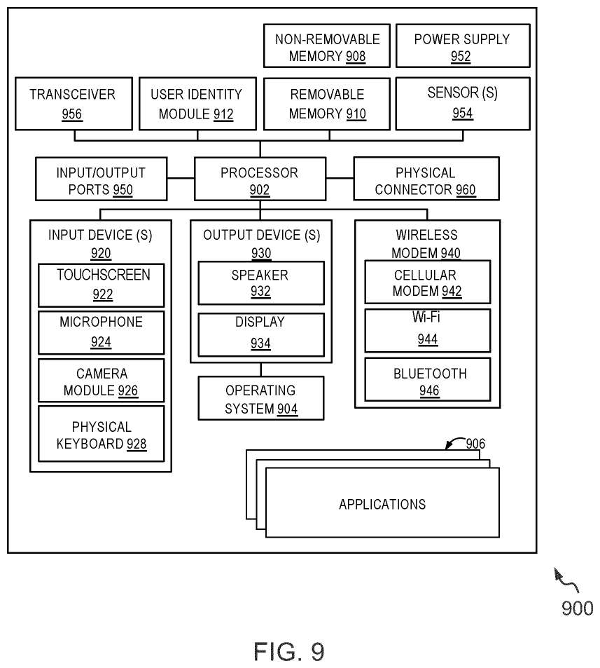

FIG. 9 is a simplified block diagram of an electronic device 900 capable of implementing various embodiments of the present disclosure. For example, the electronic device 900 may correspond to the computing device 104 of the user 106 of FIG. 1. The electronic device 900 is depicted to include one or more applications 906. For example, the one or more applications 906 may include the text extraction application 116 of FIG. 1. The text extraction application 116 can be an instance of the application that is hosted and managed by the computing device 200. One of the one or more applications 906 on the electronic device 900 is capable of communicating with a server system for performing the intelligent text extraction in real-time as explained above.

It should be understood that the electronic device 900 as illustrated and hereinafter described is merely illustrative of one type of device and should not be taken to limit the scope of the embodiments. As such, it should be appreciated that at least some of the components described below in connection with the electronic device 900 may be optional and thus in an embodiment may include more, less, or different components than those described in connection with the embodiment of the FIG. 9. As such, among other examples, the electronic device 900 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 900 includes a controller or a processor 902 (e.g., a signal processor, microprocessor, ASIC, or other control and processing logic circuitry) for performing such tasks as signal coding, data processing, image processing, input/output processing, power control, and/or other functions. An operating system 904 controls the allocation and usage of the components of the electronic device 900 and supports for one or more operations of the application (see, the applications 906), such as the text extraction application 116 that implements one or more of the innovative features described herein. In addition, the applications 906 may include common mobile computing applications (e.g., email applications, calendars, contact managers, web browsers, messaging applications) or any other computing application.

The illustrated electronic device 900 includes one or more memory components, for example, a non-removable memory 908 and/or removable memory 910. The non-removable memory 908 and/or the removable memory 910 may be collectively known as a database in an embodiment. The non-removable memory 908 can include RAM, ROM, flash memory, a hard disk, or other well-known memory storage technologies. The removable memory 910 can include flash memory, smart cards, or a Subscriber Identity Module (SIM). The one or more memory components can be used for storing data and/or code for running the operating system 904 and the applications 906. The electronic device 900 may further include a user identity module (UIM) 912. The UIM 912 may be a memory device having a processor built in. The UIM 912 may include, for example, a subscriber identity module (SIM), a universal integrated circuit card (UICC), a universal subscriber identity module (USIM), a removable user identity module (R-UIM), or any other smart card. The UIM 912 typically stores information elements related to a mobile subscriber. The UIM 912 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 900 can support one or more input devices 920 and one or more output devices 930. Examples of the input devices 920 may include, but are not limited to, a touch screen/a display screen 922 (e.g., capable of capturing finger tap inputs, finger gesture inputs, multi-finger tap inputs, multi-finger gesture inputs, or keystroke inputs from a virtual keyboard or keypad), a microphone 924 (e.g., capable of capturing voice input), a camera module 926 (e.g., capable of capturing still picture images and/or video images) and a physical keyboard 928. Examples of the output devices 930 may include, but are not limited to, a speaker 932 and a display 934. Other possible output devices can include piezoelectric or other haptic output devices. Some devices can serve more than one input/output function. For example, the touch screen 922 and the display 934 can be combined into a single input/output device.

A wireless modem 940 can be coupled to one or more antennas (not shown in FIG. 9) and can support two-way communications between the processor 902 and external devices, as is well understood in the art. The wireless modem 940 is shown generically and can include, for example, a cellular modem 942 for communicating at long range with the mobile communication network, a Wi-Fi compatible modem 944 for communicating at short range with an external Bluetooth-equipped device or a local wireless data network or router, and/or a Bluetooth-compatible modem 946. The wireless modem 940 is typically configured for communication with one or more cellular networks, such as a GSM network for data and voice communications within a single cellular network, between cellular networks, or between the electronic device 900 and a public switched telephone network (PSTN).

The electronic device 900 can further include one or more input/output ports 950, a power supply 952, one or more sensors 954 for example, an accelerometer, a gyroscope, a compass, or an infrared proximity sensor for detecting the orientation or motion of the electronic device 900 and biometric sensors for scanning biometric identity of an authorized user, a transceiver 956 (for wirelessly transmitting analog or digital signals) and/or a physical connector 960, which can be a USB port, IEEE 1294 (FireWire) port, and/or RS-232 port. The illustrated components are not required or all-inclusive, as any of the components shown can be deleted and other components can be added.

The disclosed method with reference to FIGS. 5, 6, 7A-7B, and 8, or one or more operations of the computing device 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components)) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the computing device 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a non-transitory computer-readable storage medium, wherein the computer programs are configured to cause a processor or computer to perform one or more operations. A non-transitory computer-readable storage medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

Embodiments of a computer-implemented method, a computing device, and a computer-readable storage medium according to the present disclosure are set out in the following ways:

Item 1. A computer-implemented method, comprising:
receiving, by a processor, an image comprising textual data;
extracting, by the processor, machine-readable textual data from the image, the machine-readable textual data comprising one or more words;
comparing, by the processor, each of the one or more words with a dataset comprising at least one of a domain lexicon database and a language dictionary database to determine a first set of words and a second set of words, the first set of words being words successfully matching with words available in the dataset, and the second set of words being words with no successful matches with the words available in the dataset;
splitting, by the processor, at least one word of the second set of words into two or more words to determine a third set of words that matches with the words available in the dataset; and
generating, by the processor, a textual output associated with the image based at least on the first set of words and the third set of words.

Item 2. The computer-implemented method as claimed in item 1, wherein the step of comparing each of the one or more words comprises:
calculating a highest similarity score for each of the second set of words with the words available in the dataset;
upon determining that the highest similarity score is at least equal to a threshold similarity score, detecting a word from the dataset corresponding to the highest similarity score as a corrected word for the respective word of the second set of words; and categorizing the corrected word as the first set of words.

Item 3. The computer-implemented method as claimed in any of the previous items, further comprising:
splitting the at least one word of the second set of words into the two or more words based, at least in part, on a predefined text parsing rule;
comparing the two or more words with the dataset to determine successful matches for the two or more words in the dataset; and
in response to determining that the two or more words have successful matches in the dataset, categorizing the two or more words into the third set of words.

Item 4. The computer-implemented method as claimed in item 1, wherein the language dictionary database is configured to store words in accordance with syntactic rules and semantic rules of at least one language.

Item 5. The computer-implemented method as claimed in any of the previous claims, further comprising generating, by the processor, the textual output associated with the image based at least on the first set of words, the second set of words that remain unmatched after splitting, and the third set of words.

Item 6. The computer-implemented method as claimed in item 1, wherein the image is processed based on at least one image pre-processing operation to enhance quality of the image, prior to extracting the machine-readable textual data from the image.

Item 7. The computer-implemented method as claimed in item 5, wherein the at least one image pre-processing operation comprises at least one of: (a) adaptive thresholding method, (b) image enhancement method, and (c) de-skewing method.

Item 8. The computer-implemented method as claimed in item 7, wherein the adaptive thresholding method comprises eliminating grey areas from the image.

Item 9. The computer-implemented method as claimed in item 7, wherein the image enhancement method comprises updating one or more image parameters of the image, the one or more image parameters comprising at least one of: (a) brightness, (b) contrast, (c) sharpness, and (d) aspect ratio.

Item 10. The computer-implemented method as claimed in item 7, wherein the de-skewing method comprises altering a skew angle of the image.

Item 11. A computing device, comprising:
a memory comprising executable instructions; and
a processor communicably coupled to the memory, the processor configured to execute the instructions to cause the computing device, at least in part, to:
receive an image comprising textual data;
extract machine-readable textual data from the image, the machine-readable textual data comprising one or more words;
compare each of the one or more words with a dataset comprising at least one of a domain lexicon database and a language dictionary database to determine a first set of words and a second set of words, the first set of words being words successfully matching with words available in the dataset, and the second set of words being words with no successful matches with the words available in the dataset;
split at least one word of the second set of words into two or more words to determine a third set of words that matches with the words available in the dataset; and
generate a textual output associated with the image based at least on the first set of words and the third set of words.

Item 12. The computing device as claimed in item 11, wherein to compare each of the one or more words, the computing device is further caused, at least in part, to:
calculate a highest similarity score for each of the second set of words with the words available in the dataset;
upon determination that the highest similarity score is at least equal to a threshold similarity score, detect a word from the dataset corresponding to the highest similarity score as a corrected word for the respective word of the second set of words; and categorize the corrected word as the first set of words.

Item 13. The computing device as claimed in any of items 11-12, wherein the computing device is further caused, at least in part, to:
split the at least one word of the second set of words into the two or more words based, at least in part, on a predefined text parsing rule;
compare the two or more words with the dataset to determine successful matches for the two or more words in the dataset; and
in response to determination that the two or more words have successful matches in the dataset, categorize the two or more words into the third set of words.

Item 14. The computing device as claimed in item 11, wherein the language dictionary database is configured to store words in accordance with syntactic rules and semantic rules of at least one language.

Item 15. The computing device as claimed in item 11, wherein the image is processed based on at least one image pre-processing operation to enhance quality of the image, prior to extraction of the machine-readable textual data from the image.

Item 16. The computing device as claimed in item 15, wherein the at least one image pre-processing operation comprises at least one of: (a) adaptive thresholding method, (b) image enhancement method, and (c) de-skewing method.

Item 17. A non-transitory computer-readable storage medium comprising computer-executable instructions that, when executed by at least a processor of a computing device, cause the computing device to perform a method comprising:

receiving an image comprising textual data;
extracting machine-readable textual data from the image, the machine-readable textual data comprising one or more words;
comparing each of the one or more words with a dataset comprising at least one of a domain lexicon database and a language dictionary database to determine a first set of words and a second set of words, the first set of words being words successfully matching with words available in the dataset, and the second set of words being words with no successful matches with the words available in the dataset;
splitting at least one word of the second set of words into two or more words to determine a third set of words that matches with the words available in the dataset; and
generating a textual output associated with the image based at least on the first set of words and the third set of words.

Item 18. The non-transitory computer-readable storage medium as claimed in item 17, wherein the step of comparing each of the one or more words comprises:
calculating a highest similarity score for each of the second set of words with the words available in the dataset;
upon determining that the highest similarity score is at least equal to a threshold similarity score, detecting a word corresponding to the highest similarity score as a corrected word for the respective word of the second set of words; and categorizing the corrected word as the first set of words.

Item 19. The non-transitory computer-readable storage medium as claimed in any of the previous items, further comprises:
splitting the at least one word of the second set of words into the two or more words based, at least in part, on a predefined text parsing rule;
comparing the two or more words with the dataset to determine successful matches for the two or more words in the dataset; and
in response to determining that the two or more words have successful matches in the dataset, categorizing the two or more words into the third set of words.

Item 20. The non-transitory computer-readable storage medium as claimed in item 17, wherein the image is processed based on at least one image pre-processing operation to enhance quality of the image, prior to extracting the machine-readable textual data from the image.

Item 21. The non-transitory computer-readable storage medium as claimed in item 20, wherein the at least one image pre-processing operation comprises at least one of: (a) adaptive thresholding method, (b) image enhancement method, and (c) de-skewing method.

1. A computer-implemented method, comprising:
receiving, by a processor, an image comprising textual data;
extracting, by the processor, machine-readable textual data from the image, the machine-readable textual data comprising one or more words;
comparing, by the processor, each of the one or more words with a dataset comprising at least one of a domain lexicon database and a language dictionary database to determine a first set of words and a second set of words, the first set of words being words successfully matching with words available in the dataset, and the second set of words being words with no successful matches with the words available in the dataset;
splitting, by the processor, at least one word of the second set of words into two or more words to determine a third set of words that matches with the words available in the dataset; and
generating, by the processor, a textual output associated with the image based at least on the first set of words and the third set of words.

2. The computer-implemented method as claimed in claim 1, wherein the step of comparing each of the one or more words comprises:
calculating a highest similarity score for each of the second set of words with the words available in the dataset;
upon determining that the highest similarity score is at least equal to a threshold similarity score, detecting a word from the dataset corresponding to the highest similarity score as a corrected word for the respective word of the second set of words; and
categorizing the corrected word as the first set of words.

3. The computer-implemented method as claimed in claim 1, further comprising:
splitting the at least one word of the second set of words into the two or more words based, at least in part, on a predefined text parsing rule;
comparing the two or more words with the dataset to determine successful matches for the two or more words in the dataset; and
in response to determining that the two or more words have successful matches in the dataset, categorizing the two or more words into the third set of words.

4. The computer-implemented method as claimed in claim 1, wherein the language dictionary database is configured to store words in accordance with syntactic rules and semantic rules of at least one language.

5. The computer-implemented method as claimed in claim 1, wherein the domain lexicon database is configured to store keywords corresponding to at least one domain.

6. The computer-implemented method as claimed in claim 1, further comprising generating, by the processor, the textual output associated with the image based at least on the first set of words, the second set of words that remain unmatched after splitting, and the third set of words.

7. The computer-implemented method as claimed in claim 1, wherein the image is processed based on at least one image pre-processing operation to enhance quality of the image, prior to extracting the machine-readable textual data from the image.

8. The computer-implemented method as claimed in claim 7, wherein the at least one image pre-processing operation comprises at least one of: (a) adaptive thresholding method, (b) image enhancement method, and (c) de-skewing method.

9. The computer-implemented method as claimed in claim 8, wherein the adaptive thresholding method comprises eliminating grey areas from the image.

10. The computer-implemented method as claimed in claim 8, wherein the image enhancement method comprises updating one or more image parameters of the image, the one or more image parameters comprising at least one of: (a) brightness, (b) contrast, (c) sharpness, and (d) aspect ratio.

11. The computer-implemented method as claimed in claim 8, wherein the de-skewing method comprises altering a skew angle of the image.

12. A computing device, comprising:
a memory comprising executable instructions; and
a processor communicably coupled to the memory, the processor configured to execute the instructions to cause the computing device, at least in part, to:
receive an image comprising textual data;
extract machine-readable textual data from the image, the machine-readable textual data comprising one or more words;
compare each of the one or more words with a dataset comprising at least one of a domain lexicon database and a language dictionary database to determine a first set of words and a second set of words, the first set of words being words successfully matching with words available in the dataset, and the second set of words being words with no successful matches with the words available in the dataset;
split at least one word of the second set of words into two or more words to determine a third set of words that matches with the words available in the dataset; and
generate a textual output associated with the image based at least on the first set of words and the third set of words.

13. The computing device as claimed in claim 12, wherein to compare each of the one or more words, the computing device is further caused, at least in part, to:
calculate a highest similarity score for each of the second set of words with the words available in the dataset;
upon determination that the highest similarity score is at least equal to a threshold similarity score, detect a word from the dataset corresponding to the highest similarity score as a corrected word for the respective word of the second set of words; and
categorize the corrected word as the first set of words.

14. The computing device as claimed in claim 12, wherein the computing device is further caused, at least in part, to:
split the at least one word of the second set of words into the two or more words based, at least in part, on a predefined text parsing rule;
compare the two or more words with the dataset to determine successful matches for the two or more words in the dataset; and
in response to determination that the two or more words have successful matches in the dataset, categorize the two or more words into the third set of words.

15. The computing device as claimed in claim 12, wherein the language dictionary database is configured to store words in accordance with syntactic rules and semantic rules of at least one language.

16. The computing device as claimed in claim 12, wherein the image is processed based on at least one image pre-processing operation to enhance quality of the image, prior to extraction of the machine-readable textual data from the image.

17. The computing device as claimed in claim 16, wherein the at least one image pre-processing operation comprises at least one of: (a) adaptive thresholding method, (b) image enhancement method, and (c) de-skewing method.

18. A non-transitory computer-readable storage medium comprising computer-executable instructions that, when executed by at least a processor of a computing device, cause the computing device to perform a method comprising:
receiving an image comprising textual data;
extracting machine-readable textual data from the image, the machine-readable textual data comprising one or more words;
comparing each of the one or more words with a dataset comprising at least one of a domain lexicon database and a language dictionary database to determine a first set of words and a second set of words, the first set of words being words successfully matching with words available in the dataset, and the second set of words being words with no successful matches with the words available in the dataset;
splitting at least one word of the second set of words into two or more words to determine a third set of words that matches with the words available in the dataset; and
generating a textual output associated with the image based at least on the first set of words and the third set of words.

19. The non-transitory computer-readable storage medium as claimed in claim 18, wherein the step of comparing each of the one or more words comprises:
calculating a highest similarity score for each of the second set of words with the words available in the dataset;
upon determining that the highest similarity score is at least equal to a threshold similarity score, detecting a word corresponding to the highest similarity score as a corrected word for the respective word of the second set of words; and
categorizing the corrected word as the first set of words.

20. The non-transitory computer-readable storage medium as claimed in claim 18, further comprises:
splitting the at least one word of the second set of words into the two or more words based, at least in part, on a predefined text parsing rule;
comparing the two or more words with the dataset to determine successful matches for the two or more words in the dataset; and
in response to determining that the two or more words have successful matches in the dataset, categorizing the two or more words into the third set of words.

21. (canceled)

22. (canceled)
